(19) United States
(12) Patent Application Publication
(10) Pub. No.: US 2024/0255904 A1
(43) Pub. Date: Aug. 1, 2024

(54) AUTOMATIC SENSOR TO ACTUATOR MAPPING GENERATION

(71) Applicant: OptumSoft, Inc., Vero Beach, FL (US)

(72) Inventor: David R. Cheriton, Vero Beach, FL (US)

(21) Appl. No.: 18/215,146

(22) Filed: Jun. 27, 2023

Related U.S. Application Data
(60) Provisional application No. 63/442,297, filed on Jan. 31, 2023.

(51) Int. Cl. G05B 15/02

(52) U.S. Cl. CPC G05B 15/02

(57) ABSTRACT

An inverse mapping rule is generated from a set of forward mapping rules. The set of forward mapping rules is input. A set of output parameters for the inverse mapping rule is determined based at least in part on limiting the set of output parameters to be a subset of parameters for the set of forward mapping rules. A set of input parameters for the inverse mapping rule is determined based at least in part on limiting the set of input parameters to be: output parameters and input parameters of the set of forward mapping rules. The inverse mapping rule is generated for an input value combination. Values of output parameters of the set of forward mapping rules are determined based at least in part on the input value combination and the set of forward mapping rules. A rule consequent of the inverse mapping rule is determined at least in part by resolving values of a specified output parameter from the set of output parameters for the inverse mapping rule from the input value combination. A rule antecedent of the inverse mapping rule is determined at least in part by resolving values of a specified input parameter from the set of input parameters for the inverse mapping rule from the determined values of output parameters of the set of forward mapping rules. The inverse mapping rule is output. Input is received from a sensor. A physical actuator is controlled based at least in part on the inverse mapping rule and the input from the sensor.

### CROSS REFERENCE TO OTHER APPLICATIONS

This application claims priority to U.S. Provisional Patent Application No. 63/442,297 entitled AUTOMATIC INVERSE MAPPING GENERATION FOR RULE-BASED MAPPINGS filed Jan. 31, 2023 which is incorporated herein by reference for all purposes.

### BACKGROUND OF THE INVENTION

Traditional rule-based systems may be limited in scope because they may be limited to simpler rules based on, for example, a scientific basis such as physics. It would be an improvement to expand such systems with more rules that are less simple.

### BRIEF DESCRIPTION OF THE DRAWINGS

Various embodiments of the invention are disclosed in the following detailed description and the accompanying drawings.

FIG. 1 is a functional diagram illustrating a programmed computer/server system for inverse mapping generation and control in accordance with some embodiments.

FIG. 2 illustrates a forward mapping of this nature using rules and consequent mappings.

FIG. 3 illustrates an inverse mapping rule.

FIG. 4 is an illustration of IMR generation in an example with a simple cause-context-effect rule.

FIG. 5 is an illustration of backward chaining for an IMR.

FIG. 6 is a flow diagram illustrating an embodiment of a process for inverse map generation.

FIG. 7 is a flow diagram illustrating an embodiment of a process for IMR generation for an input value combination.

FIG. 8 is a flow diagram illustrating an embodiment of a process for IMR rule subsubset generation.

FIG. 9 is an illustration of approximating a piece-wise continuous function.

FIG. 10 is a flow diagram illustrating an embodiment of a process for inverse map generation with subset generation.

FIG. 11 is a flow diagram illustrating an embodiment of a process for rule subset definition.

FIG. 12 is a flow diagram illustrating an embodiment of a process for rule subset collection definition.

FIG. 13 is a flow diagram illustrating an embodiment of a process for inverse map generation with optimized input parameter selection.

FIG. 14 is an illustration of cost calculation as an elapsed time calculation.

FIG. 15 is a flow diagram illustrating an embodiment of a process for generating an inverse mapping from a forward mapping specified by a ruleset.

FIG. 16 is a flow diagram illustrating an embodiment of a process for generating an inverse mapping from a set of forward mapping rules.

FIG. 17 is a flow diagram illustrating an embodiment of a process for generating an inverse mapping rule for an input value combination.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Behavior of a system is usually stated as cause and context->effect. However, control has an objective of an effect, so inverse mapping is useful. Generating an inverse mapping rule from a set of forward mapping rules, and controlling a physical actuator based at least in part on the inverse mapping rule and input from a sensor is disclosed.

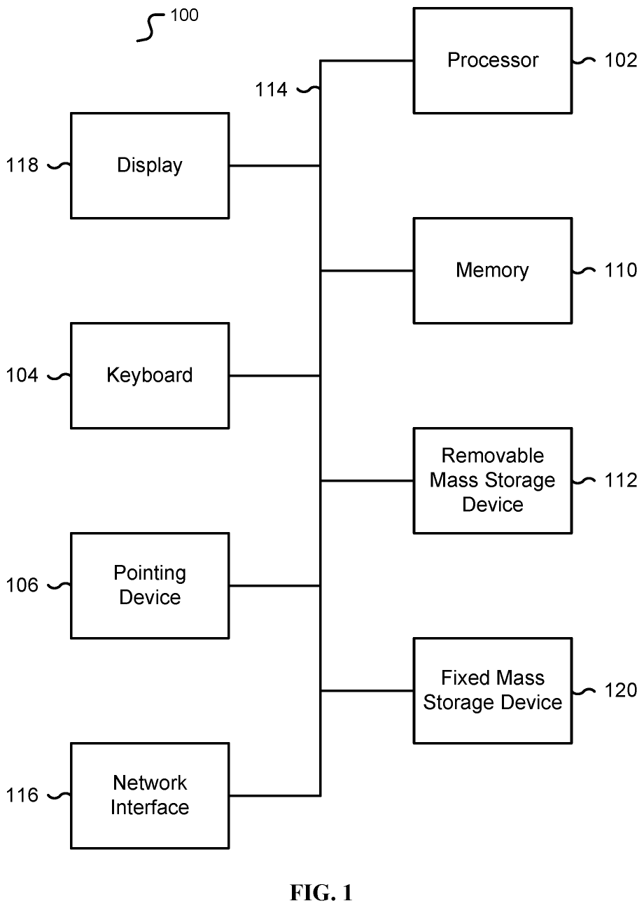

FIG. 1 is a functional diagram illustrating a programmed computer/server system for inverse mapping generation and control in accordance with some embodiments. As shown, FIG. 1 provides a functional diagram of a general-purpose computer system programmed to provide inverse mapping generation and control in accordance with some embodiments. As will be apparent, other computer system architectures and configurations can be used for inverse mapping generation and control.

Computer system 100, which includes various subsystems as described below, includes at least one microprocessor subsystem, also referred to as a processor or a central processing unit (“CPU”) 102. For example, processor 102 can be implemented by a single-chip processor or by multiple cores and/or processors. In some embodiments, processor 102 is a general purpose digital processor that controls the operation of the computer system 100. Using instructions retrieved from memory 110, the processor 102 controls the reception and manipulation of input data, and the output and display of data on output devices, for example display and graphics processing unit (GPU) 118.

Processor 102 is coupled bi-directionally with memory 110, which can include a first primary storage, typically a random-access memory (“RAM”), and a second primary storage area, typically a read-only memory (“ROM”). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as well known in the art, primary storage typically includes basic operating instructions, program code, data, and objects used by the processor 102 to perform its functions, for example, programmed instructions. For example, primary storage devices 110 can include any suitable computer-readable storage media, described below, depending on whether, for example, data access needs to be bi-directional or uni-directional. For example, processor 102 can also directly and very rapidly retrieve and store frequently needed data in a cache memory, not shown. The processor 102 may also include a coprocessor (not shown) as a supplemental processing component to aid the processor and/or memory 110.

A removable mass storage device 112 provides additional data storage capacity for the computer system 100, and is coupled either bi-directionally (read/write) or uni-directionally (read-only) to processor 102. For example, storage 112 can also include computer-readable media such as flash memory, portable mass storage devices, holographic storage devices, magnetic devices, magneto-optical devices, optical devices, and other storage devices. A fixed mass storage 120 can also, for example, provide additional data storage capacity. One example of mass storage 120 is an eMMC or microSD device. In one embodiment, mass storage 120 is a solid-state drive connected by a bus 114. Mass storages 112, 120 generally store additional programming instructions, data, and the like that typically are not in active use by the processor 102. It will be appreciated that the information retained within mass storages 112, 120 can be incorporated, if needed, in standard fashion as part of primary storage 110, for example RAM, as virtual memory.

In addition to providing processor 102 access to storage subsystems, bus 114 can be used to provide access to other subsystems and devices as well. As shown, these can include a display monitor 118, a communication interface 116, a touch (or physical) keyboard 104, and one or more auxiliary input/output devices 106 including an audio interface, a sound card, microphone, audio port, audio input device, audio card, speakers, a touch (or pointing) device, and/or other subsystems as needed. Besides a touch screen, the auxiliary device 106 can be a mouse, stylus, track ball, or tablet, and is useful for interacting with a graphical user interface.

The communication interface 116 allows processor 102 to be coupled to another computer, computer network, or telecommunications network using a network connection as shown. For example, through the communication interface 116, the processor 102 can receive information, for example data objects or program instructions, from another network, or output information to another network in the course of performing method/process steps. Information, often represented as a sequence of instructions to be executed on a processor, can be received from and outputted to another network. An interface card or similar device and appropriate software implemented by, for example executed/performed on, processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Throughout this specification, “network” refers to any interconnection between computer components including the Internet, Bluetooth, WiFi, 3G, 4G, 4GLTE, GSM, Ethernet, intranet, local-area network (“LAN”), home-area network (“HAN”), serial connection, parallel connection, wide-area network (“WAN”), Fibre Channel, PCI/PCI-X, AGP, VLbus, PCI Express, Expresscard, Infiniband, ACCESS.bus, Wireless LAN, HomePNA, Optical Fibre, G.hn, infrared network, satellite network, microwave network, cellular network, virtual private network (“VPN”), Universal Serial Bus (“USB”), FireWire, Serial ATA, 1-Wire, UNI/O, or any form of connecting homogenous and/or heterogeneous systems and/or groups of systems together. Additional mass storage devices, not shown, can also be connected to processor 102 through communication interface 116.

An auxiliary I/O device interface, not shown, can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: flash media such as NAND flash, eMMC, SD, compact flash; magnetic media such as hard disks, floppy disks, and magnetic tape; optical media such as CD-ROM disks; magneto-optical media such as optical disks; and specially configured hardware devices such as application-specific integrated circuits (“ASIC”s), programmable logic devices (“PLD”s), and ROM and RAM devices. Examples of program code include both machine code, as produced, for example, by a compiler, or files containing higher level code, for example a script, that can be executed using an interpreter.

The computer/server system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

Inverse Mapping. A mapping, for example in the mathematical sense, takes a set of input parameter values and maps them to a set of output parameter values. As one use, a mapping may characterize the behavior of a physical system by mapping between the input parameter values representing the state at the current time to specify in the output parameters indicating the values of the state in a next timestep. For example, turning up the gas knob on a stove burner, as an input, causes the eggs in the water in the pot to cook faster. The mapping in this case maps from current gas knob position, changed gas knob position, amount of water, and current water temperature as input to change in time to cook. This mapping may be determined directly from the physics of the stove, gas combustion chemistry, water thermodynamics, and so on. In particular, the gas knob turned up increases the flow of gas, which increases the size of the flame, meaning that more heat is being applied to the pot, causing the water to get hotter causing the eggs to be heated, causing the eggs to become cooked, that is, coagulated.

However, often the inverse mapping may be useful. In particular, using the above example, a forward mapping question to solve may be: if a user turns the gas knob on a stove burner by thirty-five degrees, how long will it take to cook eggs? A related inverse mapping question to solve may then be: how much rotation does a user have to turn the gas knob on a stove burner to reduce the time for eggs to cook by two minutes? Determining the inverse mapping from physics/chemistry is a challenging problem. An application may also require multiple different inverse mappings if it is controlling a stove burner, given other foods other than boiled eggs may be cooked on a gas burner.

As another example, the presence of a tiger causes a set of visual effects, including:
a large animal being present;
an animal that has orange fur and black stripes; and
an animal with sharp teeth and claws.

Other animals may cause a different set of visual effects. However, in an application that classifies animals based on appearance, the inverse mapping is required, mapping from visual effects to specific animal species or categories that cause those characteristics. That is, if the forward mapping maps between the presence of a tiger and its set of visual effects such as having orange fur and black stripes, the inverse mapping maps from observing orange fur and black stripes amongst other visual effects and determines a specific animal species/category. This inverse mapping is effectively the classification problem as referred to herein. Again, this inverse mapping is challenging to specify for a large number of species.

Moreover, some applications require the inverse mapping to be complete in the sense of providing an output for all possible legal inputs. For example, if the legal inputs are the time it takes to boil eggs, it may cover all boil times from 0 seconds to 1 year. Some applications also require the inverse mapping to be a function, that is, providing a single output value to each combination of input values. For instance, in the case of controlling a gas stove burner, there may be a single output indicating how to rotate the stove burner gas knob. Applications may also require the inverse mapping to be fast and efficient to be useful, such as a control application in which the controlled system is changing state rapidly.

An improvement for this is an automatic means of generating an efficient reliable inverse mapping from a forward mapping specification. Inverse mapping for rule-based mapping automatically generated from the specification of this mapping and a set of input and output parameters for this inverse mapping is disclosed.

The input rule-based mapping is specified as a ruleset, as referred to herein, in which:
1. each rule has an antecedent and a consequent. As referred to herein, a rule antecedent is the “if” part of the rule such as a protasis, and a rule consequent is the “then” part of the rule such as an apodosis;
2. each rule is specified as parameterized in terms of ruleset variables which are either inputs or determined in part from other rule consequents;
3. each rule has a consequent that is a mapping from ruleset variable values to other ruleset variable values that is (and/or in some cases only) applicable when the ruleset variable values cause the antecedent of the rule to evaluate to true. That is, the associated consequent either determines one or more output parameter values for the mapping or determines values for a ruleset local variable used in another rule in the ruleset; and
4. for each consequent of each rule, there is a means to invert the consequent mapping for parameter values for which its antecedent is true, that is, a consequent inverse mapping.
   The input rule-based mapping is referred to herein as the forward mapping.

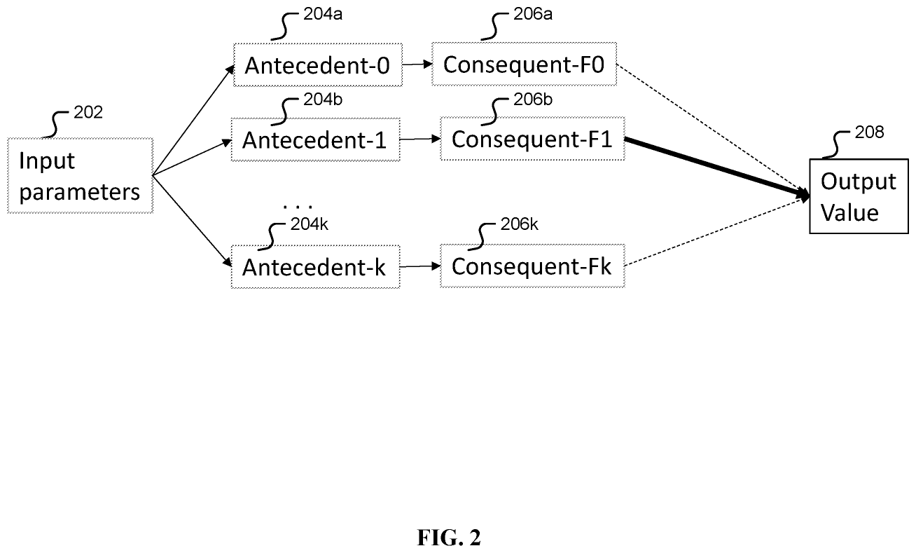

FIG. 2 illustrates a forward mapping of this nature using rules and consequent mappings. As shown in FIG. 2, the forward mapping uses rules and consequents that produce values. As depicted in FIG. 2, the input parameter values (202) are used to evaluate the rule antecedent (204a), (204b), . . . (204k) of the rules implementing the forward mapping. The figure also shows corresponding consequent functions (206a), (206b), . . . (206k), and the resultant output value(s) (208). In FIG. 2, the antecedent “Antecedent-1” (204b) evaluates to true, so the output value(s) (208) are produced by the consequent function, “Consequent-F1” (206b). If a given rule consequent (206a), (206b), . . . (206k) comprises multiple clauses, each producing a separate value, the actual output values (208) are viewed as the compound value comprising each of these multiple values.

For example, informally, a forward mapping rule for a gas stove may be structured as:
increasing gas to burner implies hotter burner AND increased gas usage,
   where “hotter burner” and “increased gas usage” are each consequent clauses. Therefore, the output value for this rule when its antecedent “increasing gas to burner” is true is the compound value [burnerTemperature, gasUsage], where burnerTemperature and gasUsage are ruleset variables. With a multi-clause consequent, the means to invert the consequent is normally a means to invert each of the consequent clauses.

With a different set of input values (202), a different antecedent may be true (204a), (204b), . . . (204k), causing a different consequent (206a), (206b), . . . (206k) to produce the output value (208). With some forward mappings and input values (202), multiple rules may have their antecedents evaluate to true, so there are multiple outputs. The forward mapping is referred to as a mathematical mapping rather than a function because multiple output values are produced in this case. It is only a function mathematically if it produces a single output value for all possible inputs, as referred to herein.

As referred to herein, a rule is simply a traditional “if . . . then”/conditional statement that is identified and may be manipulated by the compiler. Without limitation, it is not meant herein to imply or require or exclude the rules being executed by a rule execution engine as may be done traditionally. It is assumed that the compiler may evaluate a rule antecedent for a given set of input values. Otherwise, it may not be possible to evaluate the rules for a given input.

As referred to herein, the term ruleset variable is used for a parameter in a ruleset, whether input, output, or used internal to the ruleset as the consequent of a rule. The latter is referred to herein as a ruleset local variable.

Using the gas burner example above,
increasing gas to burner implies hotter burner AND increased gas usage,
   a forward mapping rule example may be:

if ( waterTemperature less than boiling AND gasLevel less than maximum ) then
thermalChange = waterThermalCalc(gasLevel,gasDelta,waterAmount)

Here, waterThermalCalc is a function that returns the thermal change based on the change in the gas level, as indicated by the gasDelta parameter. The waterTemperature, gasLevel, gasDelta, waterAmount, and thermalChange are all ruleset variables with the thermalChange being an output ruleset variable, and waterTemperature, gasLevel, gasDelta, and waterAmount being input ruleset variables.

An inverse mapping as referred to herein is specified by a set of inverse input parameters and output parameters and a forward mapping specified as above. The inverse output parameters are included in the parameters of the forward mapping. The inverse input parameters are included in the parameters of the forward mapping. The forward mapping input parameters that are not included in the inverse output parameters, if any, remain as inverse input parameters and are referred to herein as context parameters, which may be referred to as a condition parameter. Normally, the context parameters indicate the current environment or state or context under which the ruleset is being evaluated and are not directly under the control of the application.

For example, using the forward mapping rule example above, waterTemperature, gasLevel and waterAmount are context input parameters to the forward mapping, thermalChange is the output parameter, and gasDelta is the independent input parameter, referred to herein as the controllable input parameter. Therefore, an inverse mapping may be specified as having input parameter thermalChange and output parameter gasDelta.

As part of automatically compiling a forward mapping to output an inverse mapping the compilation may check that the inverse mapping is complete and optionally unambiguous, reporting errors as it encounters them. As referred to herein, complete means it is defined for all legal values of the inverse input parameters. Also as referred to herein, unambiguous means there is a single output value and/or compound value for each legal input.

The forward mapping may be referred to as cause-effect mapping. This is because a “cause” specified as one of its input parameters, when true, implies the “effect” determined by its output. In traditional cause-effect terminology, the term inverted is clear and referred to herein in part because the disclosed outputs a mapping that maps from an effect achieved to a cause, the inverse of the input forward mapping which essentially maps from a cause to an effect.

With context inputs, as defined earlier, the forward mapping is a “cause-context-effect” mapping, determining the effect, given specified cause and context parameters. The inverse mapping is then indicating: “what is the cause of this effect, given these context values?” For example, an inverse mapping may be: what setting of the burner X is needed to cook typical eggs in nine minutes, given there are Y eggs and they are in Z liters of water?

As described earlier, there may be multiple inverse mappings for a given forward mapping, one for each different set of specified inverse input and output parameters, for example, a context parameter becoming an inverse mapping output parameter rather than remaining as an input to the inverse mapping. Continuing the example above, if a first inverse mapping is “What setting of the burner X is needed to cook typical eggs in nine minutes, given there are Y eggs and they are in Z liters of water?” a second inverse mapping may be “How many liters of water is needed to cook typical eggs in nine minutes, given there are M eggs and the setting of the burner is N?”

Conjunctive Normal Form. The antecedent of each rule may be assumed to be in conjunctive normal form (CNF). As referred to herein CNF is a conjunction of clauses, each of which is a disjunction or a simple clause. An input rule whose antecedent is provided not in CNF may be converted to CNF using standard traditional techniques. That is:
Move negations into the formula, repeatedly applying De Morgan's Law, so that all negations only apply to atoms. This produces a formula in negation normal form; and/or
Use the distributive law repeatedly when a disjunction occurs over a conjunction. When this has been applied as much as possible, the formula is in CNF.
   Therefore, without loss of generality and/or limitation, the antecedents of the rules in the input forward mapping are assumed to be in CNF herein.

A consequent in the forward mapping is assumed to be of the form
outputParameter=consequentMapping(rulesetVariables)
   where outputParameter is specified as one of the output parameters of the forward mapping. It may also be structured as multiple clauses of the form

(outputParameter0 = consequentMapping0(rulesetVariables)) AND
consequentMapping1(rulesetVariables))... AND (outputParameterk =
consequentMappingk(rulesetVariables))

This is a conjunction of clauses producing a compound output value.

Inverse Mapping Rule (IMR). For a given input forward ruleset and inverse specification, the inverse mapping is specified as one or more inverse mapping rules (IMR). An IMR, as referred to herein, maps from the inputs of the inverse specification to the outputs of the inverse specification.

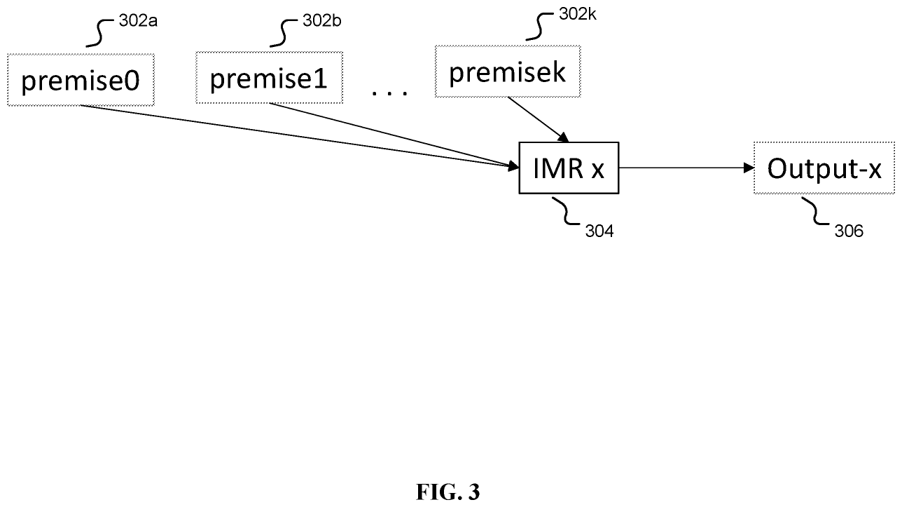

FIG. 3 illustrates an inverse mapping rule. As shown in FIG. 3, IMR rules in a ruleset may be evaluated to immediately determine an output, if there is one. Thus as depicted in FIG. 3, if premise0 (302a), premise1 (302b), . . . through premisek (302k) are true, the IMRx rule (304) is activated providing output Output-x (306).

The IMR has its antecedent specified in CNF as the conjunction of clauses, each clause corresponding to a forward inferencing clause involved in forward mapping, mapping the input values for the parameters to the forward outputs. Thus, with the values, these values may be mapped onto the inputs and outputs of the IMR, thereby specifying this IMR.

Thus, an IMR exists for particular input values if there is a forward mapping in the input mapping rules from the forward parameters with the corresponding values to the forward output parameters with the corresponding values.

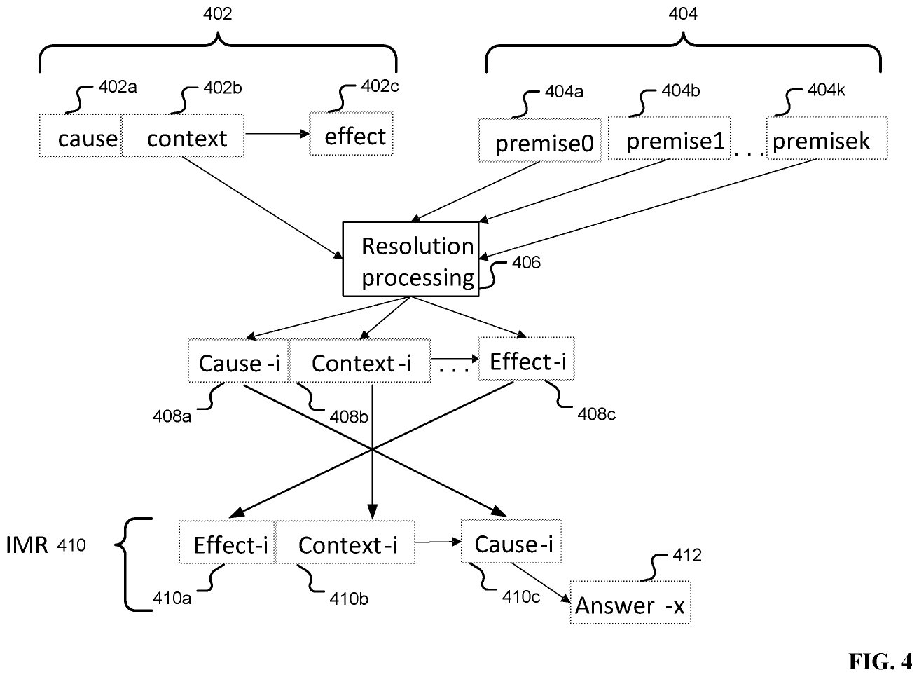

FIG. 4 is an illustration of IMR generation in an example with a simple cause-context-effect rule. FIG. 4 depicts a single forward mapping input rule (402) with cause (402a), context (402b), and effect (402c), and a single input value set (404) with premise0 (404a), premise1 (404b), . . . premise k (404k). The resolution processing (406) substitutes the values of the input value set into the causes of the input rule to produce “cause-i” (408a) and “context-i” (408b), which if true, then implies “effect-i” (408c). If the antecedent, as the conjunction of cause-i (408a) and context-i (408b) evaluates to false, no IMR (410) is generated. Otherwise, the IMR (410) is formed by mapping the effect-i (410a) and context-i (410b) to the antecedent of the inverse ruleset and cause-i (410c) to the consequent of the inverse ruleset, with effect-i (410a) and cause-i (410c) modified as described below. The resulting IMR (410) maps effect-i (410a) to cause-i (410c) value, assuming context-i (410b) is true. Thus for the IMR shown in FIG. 4, if inputs are effect-i and context-i, then an output/cause is cause-i. An output value may be answer-x (412) to this IMR.

Note that the IMR (410) indicates that it is possible that cause-i (410c) is the cause that produced effect-i (410a) in context context-i (410b), not that it necessarily is. This is because there may be another cause that may also produce, and therefore may also have produced, effect-i (410a) with the given context.

As part of this remapping of effect-i (410a) to the antecedent, if the forward mapping rule effect clause (402c) produces a non-boolean value, effect-i (410a) is effectively translated to:
effect(i-parameters)==effect-i value.
or
effect(i-parameters) in effect-i range
   if effect-i (410a) is expressed as a range. That is, the effect is required to be equal to, or in the range of, the input value or range corresponding to this ruleset variable.

For cause-i (410c) to be provided in the output of the inverse mapping, it is determined as the value that causes the antecedent (402a), (402b) to be true in the associated forward mapping rule (402). For example, considering the earlier example of a forward mapping rule for thermalChange,

if ( waterTemperature less than boiling and gasLevel less than maximum ) then
thermalChange = waterThermalCalc(gas Level,gasDelta,waterAmount)

with an inverse mapping specified to have gasLevel in the consequent,

if ( waterTemperature less than boiling and gasLevel less than maximum ) then
gasDelta = inverseWaterThermalCalc(gas Level,thermalChange,waterAmount)

cause-i (410c) is output as the value that causes the thermalChange to equal the specified thermalChange input value for the i-th input value set.

An inverse mapping may be specified to have an output parameter in the same form as it appears in a clause in the antecedent. For example, using again this example of the gasDelta forward rule, if the inverse is to output the water temperature range, it may be sufficient to output as the consequent “water temperature in the range less than boiling” for the IMR of the example rule.

It is possible that there is no IMR for a given set of values of the input parameters. This is because there may be no forward inference sequence with the input/forward mapping rules that produces the specified consequent for any set of inverse input parameter values. Conventional backward chaining through the forward map rules may fail for the same reason. This is evident by considering so-called backward chaining in a ruleset, as arises in traditional techniques. Backward chaining as referred to herein is equivalent to determining the cause in the inverse mapping for a specific effect value. However, backward chaining is performed during rule evaluation/run-time wherein by contrast, compiling and thereby generating an inverse mapping before the application using this inverse mapping is actually using it is disclosed herein.

An IMR is logically an efficient alternative to backward chaining in the forward mapping ruleset. This is because backward chaining determines a directed acyclic graph (DAG) from the inverse mapping for those values to the output for the inverse mapping, at least in terms of the consequent for the resulting IMR.

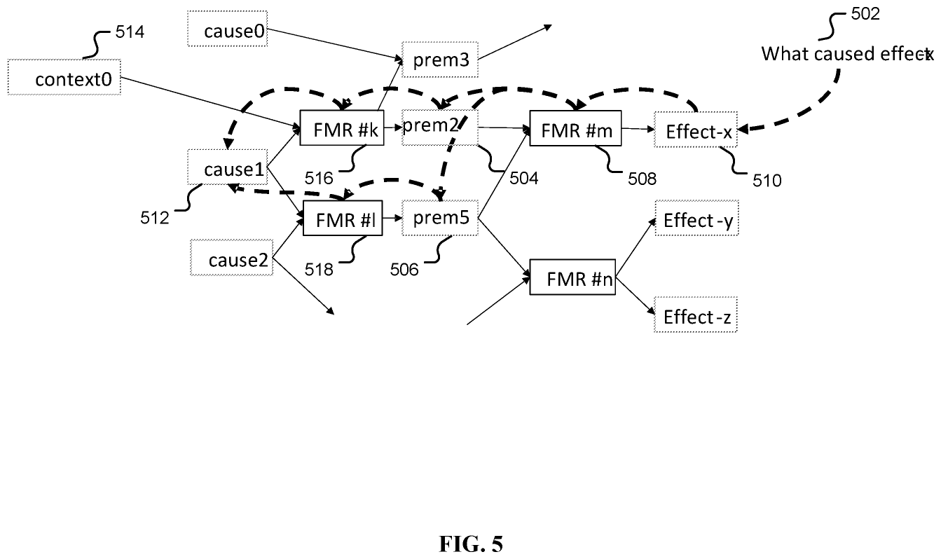

FIG. 5 is an illustration of backward chaining for an IMR. As shown in FIG. 5, reverse search through a DAG structure may find a corresponding leaf/cause that if true, allows the cause-effect as a proposition with that effect to be a true statement. As depicted in FIG. 5, the cause of effect-x (502) is determined to be because prem2 (504) and prem5 (506) cause forward mapping rule #m (508) to hold, implying effect-x (510). Prem2 (504) is implied by cause1 (512) and context0 (514) through FMR #k (516) and prem5 (506) is implied by cause1 (512) through FMR #1 (518). Therefore, effect-x (510) implies cause1 (512) with context0 (514) in the inverse mapping.

In general, in a DAG, the nodes of the graph correspond to the premises, referring herein to clauses that are true, and the edges correspond to the rules of inference that are applied. Therefore, an IMR in CNF is one in which rule antecedent is the conjunction of these premises including that associated with the consequent in the original input ruleset. Thus, with an IMR, if all its premises are true, it immediately fires in rule evaluation, directly providing the inverse mapping in its consequent. There may be multiple IMRs for a given combination of input values if there are multiple combinations of input values to the forward mapping that map to the same output value.

Consequent Inversion Mapping. As above, there must be a consequent inverse mapping for each rule consequent in order to generate the inverse of the forward mapping. For instance, for the inverse in which the gasDelta is the output and thermalChange is an input, there needs to be an inverse mapping
gasDelta=inverseWaterThermalCalc(gasLevel,thermalChange,waterAmount)
   which returns the gasDelta value such that, for when the antecedent is true, means that:
thermalChange=waterThermalCalc(gasLevel,gasDelta,waterAmount)
   That is, it is the inverse for ruleset variable values that cause the antecedent to be true. This inverse may be required because an inverse rule needs to be able to determine when a consequent, transformed to a clause in the antecedent in an IMR, is true.

The inverse mapping may be explicitly specified in the forward mapping or it may be derived from the specification of the consequent mapping. To take a different example in kinematics, suppose the consequent mapping for rule Ri is mapping the parameters of force, mass, and speed to acceleration:

accel = K*throttle/mass for speed in SpeedRangei, throttle in
ThrottleRangei and mass in MassRangei.

That is, if the throttle, mass, and speed are in the specified range, the acceleration is given by this formula and is in the AccelRangei. Therefore, there is an inverse function so it is invertible. In the above example, it is:

throttle = accel*mass/K for speed in SpeedRangei, throttle in
ThrottleRangei, and mass in MassRangei.

Note that if the speed is higher than the specified SpeedRangei, it may be that wind resistance causes the function, and its inverse, to no longer be accurate. This is a reason for the forward mapping to be conditioned by the rule antecedents. That is, many forward mapping may not be accurately computed by a traditional closed-form formula because the mapping is not continuous in the mathematical sense.

As disclosed herein, an inverse function may be provided for one or more of the consequent functions used in the forward mapping. For example, using the heating example, the consequent may be:
gasDelta=gasDeltaCalc(gasLevel,thermalChange,waterAmount)
   where gasDeltaCalc is the inverse function to waterThermalCalc, used in the forward mapping.

For completeness, the forward ruleset in this example

if ( waterTemperature less than boiling and gasLevel less than maximum ) then
thermalChange = waterThermalCalc(gasLevel,gasDelta,waterAmount)

may contain rules for contexts when the waterTemperature is equal to boiling as well as for when the gasLevel is at the maximum.

If a consequent mapping is a monotonic mapping F, implying there is an ordering defined on the inputs and the outputs, the inverse values may always be computed using binary search. In particular, iF(x), the inverse of F, may be computed for parameter x by computing F(y) for different values of y, selecting a value y2 greater than y1 when F(y1) is less than x and less than y1 when F(y1) is greater than x, or vice versa (if the value of F is inversely related to parameter x). This is simply a binary search, and other forms of search may be used.

In the above example, the search would use a medium value for gasDelta to determine the thermalChange for that value, and then pick a next value for gasDelta that is less or more, depending on whether the computed thermalChange value is greater than or less than the target value provided by the thermalValue in the i-th input parameter value combination. This process repeats until the gasDelta value is determined with sufficient accuracy. If the function Fi is strictly monotonic, there is a unique value for this inverse. Otherwise, it may be multiple values from the minimum to maximum input value that produces this target value. Note that the thermal change is not strictly monotonic over its entire range if the water temperature is equal to boiling because water may not exceed that temperature without undergoing the phase change to steam.

One inverse mapping with the example forward mapping

if ( waterTemperature less than boiling and gasLevel less than maximum ) then
thermalChange = waterThermalCalc(gasLevel,gasDelta,waterAmount)

has the gasDelta as the output,

if ( waterTemperature less than boiling and gasLevel less than maximum ) then
gasDelta = gasDeltaCalc(gasLevel,thermalChange,waterAmount)

the thermalChange as the independent input and the waterTemperature, gasLevel and waterAmount as the context input parameters. In this sense, the inverse mapping is normally the result of “pivoting” the mapping around the context inputs, making the independent inputs be the outputs of the inverse mapping and the outputs of the forward mapping be the independent inputs. The qualifier normally is used herein because in some cases, what is a context parameter on the forward mapping may be specified as an output for the inverse mapping.

Using again the above forward mapping rule

if ( waterTemperature less than boiling and gasLevel less than maximum ) then
thermalChange = waterThermalCalc(gasLevel,gasDelta,waterAmount)

as the example, the inverse may specify the waterAmount as an output instead.

if ( waterTemperature less than boiling and gasLevel less than maximum ) then
waterAmount = waterAmountCalc(gasLevel,thermalChange,gasDelta)

That is, if the application needed to determine the water amount for which the given gasDelta, waterTemperature and gasLevel would produce a specified amount of thermalChange, the inverse mapping would specify the waterAmount as the output parameter. In the rest of this disclosure, it is assumed for each forward consequent mapping F, there is a corresponding inverse iF.

One degenerate version of the forward mapping arises when the forward mapping is entirely strictly monotonic, so there is logically a single rule whose antecedent is “true” and its consequent is the single strictly monotonic function that implements this mapping.

Another degenerate form of this forward mapping is one in which each rule in the ruleset has a single constant output value for its consequent. That is, each function in each rule returns a single value for all values of the parameters. An objective handled by the disclosed is forward mappings that entail multiple rules and associated non-trivial consequent mappings.

Autogeneration of An Inverse Mapping. In the general case of autogeneration of an inverse mapping, the input ruleset may contain a multiplicity of forward mapping rules and there may be a large number of input value combinations. Moreover, in a ruleset, there may be effects that are the consequent of rules whose antecedents depend on premises that are not directly determined by the ruleset input parameters.

For example, with a gas stove, the rules may indicate that turning the gas knob further increases the gas to the burner as the effect, not the change in thermal level. Then, a separate rule indicates that more gas implies a bigger flame as the effect. And, yet another rule indicates that a bigger flame implies increased thermal level. Therefore, it is necessary to forward chain (i.e. forward inference) through these rules to get to the increased thermal level, if that is the actual output. That is, the increased gas effect causes the antecedent to bigger flame to be true which causes the consequent, namely increased thermal level, to be true.

Therefore, the general method may need to consider the cross-product of all possible input parameters for the input forward mapping and for each combination, evaluate the forward ruleset with that combination and convert the resulting consequents, given these values, to premises, and, given these additional premises, forward-chain using these rules, adding new premises based on this forward chaining, repeating until one or more premises complete the inverse consequent corresponding to this input combination, or determine that the inverse consequent may not be determined from the input ruleset for this input value combination.

At that point, if successful, then for this input combination, one or more IMRs may be output using the remapping as in FIG. 4. That is, the consequent corresponds to the parameter values of the parameters that are identified as part of the output of the inverse mapping and the antecedent corresponds to the combination of context input parameter values and outputs of the input mapping that are input parameters in the inverse mapping.

Each forward chaining action follows the normal resolution method in traditional techniques, namely: first, determining the rules for which the rule antecedent evaluates to true with the current premises; second, adding the consequent of each such rule to the set of premises; and third, repeating the above steps with the new premises.

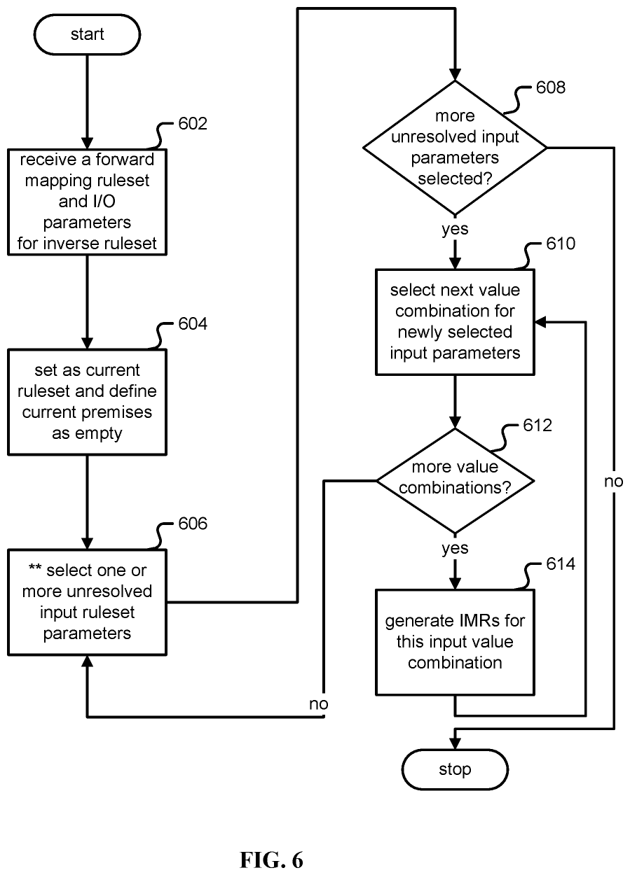

More specifically, the method of generating the inverse mapping specified by inverse mapping input and output parameters and a forward mapping RS with input parameters and its output parameters comprises the steps illustrated in FIGS. 6, 7, and 8.

FIG. 6 is a flow diagram illustrating an embodiment of a process for inverse map generation. In one embodiment, the process of FIG. 6 is carried out by the system of FIG. 1. As a running example to illustrate inverse generation, consider an operand rule set for a gas stove with input parameters gasLevel, burnerTemperature and waterAmount with result being boilTime. The gasLevel can be low, medium or high. The burner temperature can be warm, hot or veryHot. The waterAmount can be quarter, half or full. The boil time is in ranges quick, short and long, corresponding to 1 to less than 3 minutes, 3 to less than 5 minutes, and 5 minutes to 100 minutes. The rules are:

| | |
|---|---|
| 1. | warm & dontCare −> long |
| 2. | hot & quarter −> short |
| 3. | hot & half −> short |
| 4. | hot & full −> long |
| 5. | veryHot & quarter −> quick |
| 6. | veryHot & half −> short |
| 7. | veryHot & full −> short |
| 8. | low −> warm |
| 9. | med −> hot |
| 10. | high −> veryHot |

The inverse ruleset is specified as having input parameters waterAmount and boilTime with result being gasLevel.

In step (602), a forward mapping ruleset RS is accepted as input along with a specification of the input and output parameters for the inverse mapping to be generated. The latter output parameters are required to be a subset, or all of, the ruleset parameters for RS. Similarly, the latter input parameters are required to be the RS output parameters and any RS input parameters that are not specified as the inverse ruleset output parameters. In the running example, the output result parameter is gasLevel, which is an input to the operand ruleset.

In step (604), the forward mapping ruleset is specified as the current rule subset and the current premises set is empty. The “current” premises as referred to herein are the parameters and clauses that have been resolved at this point, either by the current input values for parameters or by forward inference.

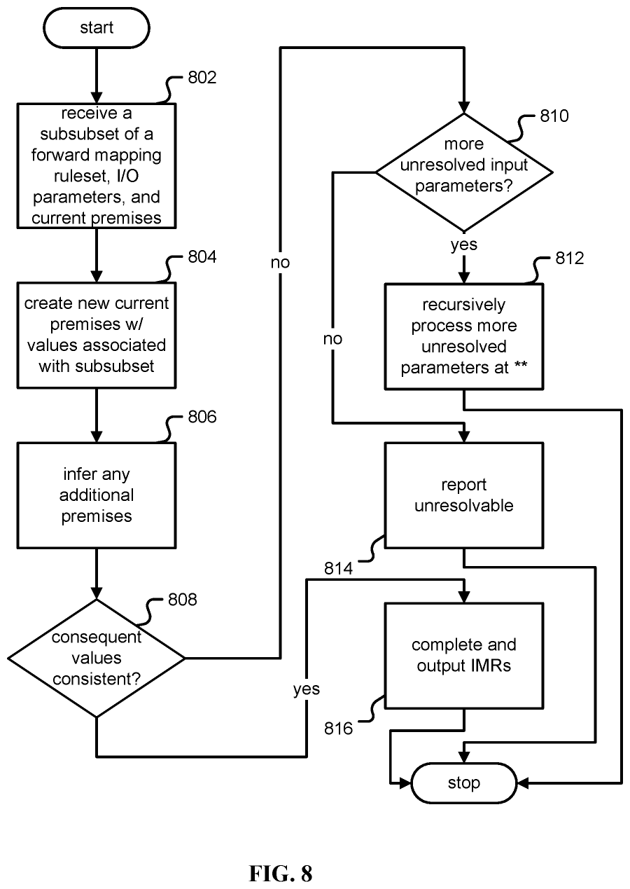

In step (606), designated in FIG. 6 by the ** symbol for cross-referencing in FIG. 8, one or more unresolved inverse mapping input parameters are selected. In one embodiment, a single additional unresolved parameter is selected in this step. In the running example, assume that gasLevel is selected as this unresolved parameter.

In step (608), in the event there are no more unresolved inverse mapping input parameters selected, or alternately put, in step (606) there are no additional input parameters selected, control is transferred to completion of the process; otherwise, control is transferred to step (610). In step (610), the next value combination is selected for the newly selected input parameters. If there is a single newly selected input parameter, there is a single value in this “combination.” For example, if the single input parameter gasLevel is selected and has values low, medium, and high, the processing iterates over each of these values.

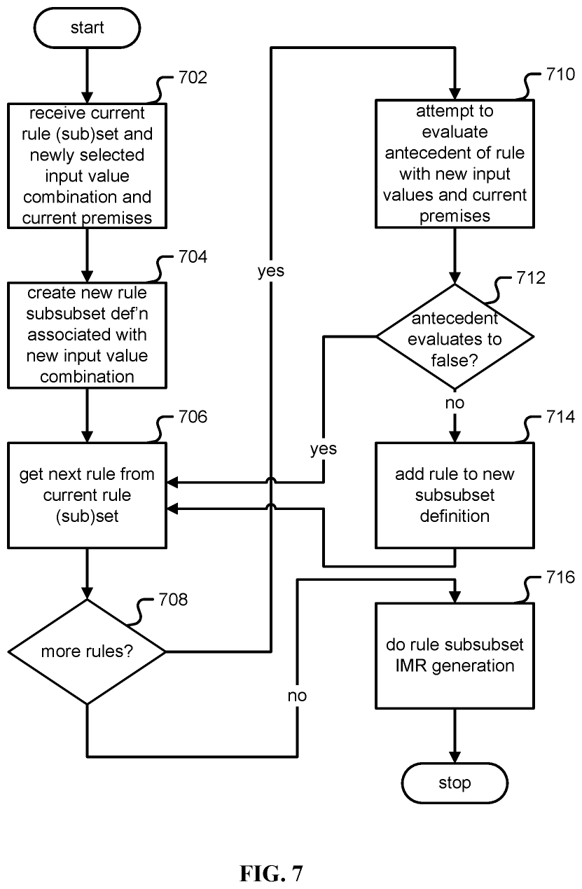

In step (612), in the event there are no more value combinations unresolved, control is transferred to step (606); otherwise control is transferred to step (614). In step (614), the input parameters as marked resolved and IMRs are generated for this input value combination, as is detailed in FIG. 7. In the running example, on the first iteration the value low is selected for the gasLevel. Control is then transferred to step (610). In the running example, it would then select medium as the next value to consider, and then on further transfer to step (610) the final value of high.

Note that step (606) is recursively invoked as shown later in FIG. 8. When this step is recursively invoked, the rule subset considered a “current rule subset” is the subset of the forward mapping rules that are not determined to be false for a “current” set of premises. Continuing the gas stove example, if this step is recursively invoked with the rule subset corresponding to the low rules for a gas stove, the subset it is recursively invoked with does not contain any of the forward mapping medium or high rules. Therefore, with each recursive invocation, the current rule subset is being reduced, possibly down to a single rule. Therefore, by resolving more and more of the ruleset variables, either the output of the consequent mapping is determined or it is not possible to generate the inverse for the current input parameter values.

FIG. 7 is a flow diagram illustrating an embodiment of a process for IMR generation for an input value combination. In one embodiment, the process of FIG. 7 is part of step (614) in FIG. 6 and/or is carried out by the system of FIG. 1.

FIG. 7 shows the process of IMR generation using the “current rule (sub)set,” “current premises,” and the newly selected input value combination. In step (702), this current rule (sub)set, current premises, and newly selected input value combination are received, for example as shown in the flow of FIG. 6. In this step (702), a new “premises” set is created from the current premises and the new input values in this input value combination, that is, the ruleset parameter whose values are now specified and antecedent clauses that are known to be true or false. In the running example, on the first invocation of this processing, the gasLevel in the premise is set to indicate low as the current assumed or premised value for that input.

In step (704), an empty new rule subsubset definition is created. The term “definition” is used herein because this processing may just produce a description of the rules in this new subsubset rather than an explicit rule subset data structure.

In step (706), iteration over the rules in the current subset commences and/or is continued. The next unprocessed rule in the current rule (sub)set is retrieved for processing. In step (708), in the event there is another unprocessed rule, control is transferred to step (710); otherwise control is transferred to step (716).

In step (710), an attempt is made to evaluate this rule antecedent using the known ruleset variable values based on the current premises and the input value combination associated with this new rule subsubset definition. Note that the evaluation may succeed even without all the ruleset variable values resolved in some cases. For instance, if a clause of the CNF antecedent of a rule is gasLevel:medium and the input value for the gasLevel is low as indicated for the first invocation, the entire antecedent is known to be false even if other ruleset variables in the antecedent are not resolved.

In step (712), in the event the rule does not evaluate to false, either because it evaluates to true or may not be evaluated because of unresolved ruleset variables, control is transferred to step (714); otherwise control is transferred to step (706). In step (714) the rule is included in the current rule subsubset and control is transferred to step (706). In the running example, the only rules known to be false in step (714) are rules 9 and 10, because their antecedent is made false by the gasLevel:low, based on the current premise. Here, the term “subsubset” is used because the input ruleset at step (702) is potentially a subset of the operand ruleset and the processing of FIG. 7 is creating a subset of that subset. In the example, on this first invocation of this processing, this subsubset consists of rules 1 through 8 inclusive.

In step (716), where it was established in step (708) that there are no more unprocessed rules, IMR generation is performed for this rule subsubset, as detailed in FIG. 8. This generation is performed on a rule subsubset that is defined based on these resolved ruleset variables and clauses such that each subset contains all the rules from the input ruleset that are not known now to be false, based on the values of the current resolved ruleset parameters, including the value(s) associated with this subset for the newly selected input parameter(s). In the example, on the first invocation, this rule subsubset comprises rules 1 through 8 inclusive, as mentioned above.

In particular, if none of the clauses in the CNF antecedent of rule R evaluate to false for a given set of premises, either because they evaluate to true or there are unresolved ruleset variables that preclude completing the evaluation of the clause, then rule R is present in the corresponding rule subsubset. To illustrate, in the running example, the burnerTemperature is an inverse mapping input parameter and has not been resolved so the antecedents of rules 1 thru 7 are not known to be false.

In one embodiment, these rule subsubsets definitions are realized as an explicitly generated data structure per input value or range with each having an explicit collection of rules in that subsubset.

In the special case of an embodiment that selects all unresolved input parameters in step (704), each rule subset may be generated on demand for each next rule subset from the “definition,” which is the same as described above, but with all input parameters resolved to the associated input values. This special handling avoids the overhead of explicitly generating the large number of (sub)subsets required by all combinations of values for all input parameters.

FIG. 8 is a flow diagram illustrating an embodiment of a process for IMR rule subsubset generation. In one embodiment, the process of FIG. 8 is part of step (716) in FIG. 7 and/or is carried out by the system of FIG. 1. FIG. 8 shows the processing of a rule subsubset and premises to generate zero or more IMRs.

In step (802), a subsubset of a forward mapping rule and current premises are received along with the specification of inverse ruleset input and output parameters. The “current premises” indicate which ruleset variables have been resolved at this point, that is, their respective values are known. It also indicates which other clauses in the antecedents of forward mapping rules are known because of these values and forward inferencing. In the running example, only the gasLevel parameter is known when this step is first invoked and the gasLevel is low.

In one embodiment, each subset is explicitly generated, not just defined. On the other hand, a rule subset may be simply defined so it is generated at this point. For instance, if all of these unresolved input parameters are selected in the processing in FIG. 6, the definition may simply indicate the next cross-product combination of input values to resolve; that is, to provide values to all of the input parameters. One embodiment may instead select multiple but not all unresolved inverse input parameters.

In step (804), it creates a new set of current premises by adding the premises based on the input parameters associated with the selected rule subset together with the original current premises. In the running example, if the selected rule subsubset corresponds to gasLevel being low” this premise is added to the original current premises to form the new current premises.

In step (806), forward chaining/inference is applied to see if additional premises may be determined from the rules whose antecedent is true, based on these new current premises. For example, now that the gasLevel is known to be low, the antecedent for rule 8 evaluates to true, so its consequent is added to the new current premises, namely, the burner on the stove is warm, resolving the burnerTemperature parameter. This resolving of the burnerTemperature to warm means that rules 2 through 7 are known to be false and so are eliminated from this current subsubset. In general, a consequent determined by forward chaining may resolve a ruleset local variable or an inverse output parameter.

This forward chaining is applied repeatedly until no further premises are added to the new current premises. This forward chaining terminates by this criterion because there are a finite number of input rules and a finite number of ruleset variables and the processing detects when a ruleset variable is already resolved. Therefore, the iterative forwarding chaining either runs out of unresolved ruleset variables or is unable to resolve additional ruleset variables. In the running example, the forward chaining is only able to resolve the burnerTemperature and eliminate all but the rule 1, so the forward inferencing step (806) completes.

As part of this forwarding chaining step, the processing may detect a rule that attempts to resolve a ruleset variable that is already resolved, but to a different value than previously resolved. For example, if the input ruleset contains a rule Rj that is true in response to the stove burner being hot but has the (erroneous) consequent of the pot as being cold, it conflicts with the earlier Ri and is reported as a conflict in the input ruleset. Therefore, the inverse ruleset generated is reliable in the sense that either there are no inconsistencies in the input ruleset or else an inconsistency error is reported.

In step (808), in the event that the consequents for the rules in the current subset are consistent and resolved, control is transferred to step (816); otherwise control is transferred to step (810). For example, if the stove gasLevel is the inverse mapping output parameter and the forward chaining resolves this parameter to the same value for each rule in the current rule subsubset, their consequents are considered “consistent.” In the degenerate case, the current subset contains a single rule, so the consequents are consistent and resolved if the consequent is resolved for this one rule. In the running example, in this first invocation of this step, there is a single rule, namely rule 1. as above. Therefore, it goes to step (816).

In step (816), the processing generates an IMR for each rule in this subset, essentially following the mapping illustrated in FIG. 4. That is, the inverse mapping outputs are determined from the values of the original input ruleset input parameters and the antecedent parameter values are generated from the values of the original input ruleset output parameters. This generated IMR is then added to the inverse mapping ruleset if this IMR is not already present in the inverse mapping ruleset. The process completes, returning for example to its point of invocation at step (716) in FIG. 7. In this running example, it therefore outputs the rule waterAmount:dontCare & boilTime:long->gasLevel:low.

In step (810), in the event there are more unresolved input parameters, control is transferred to step (812); otherwise control is transferred to step (814). Advancing the running example, when the top-level iteration in FIG. 6 selects gasLevel:medium as the next value, it infers that the burner is hot and so there are two rules at this step in the processing, so it continues to step (812).

In step (812), the processing of FIG. 6 is recursively invoked starting at step (606) denoted ** with the new set of current premises. For the advanced running example with gasLevel:medium, it invokes step (606) which selects the remaining ruleset parameter of waterAmount, and performs this processing sequence on that ruleset parameter. In particular, it first selects waterAmount:quarter so rule 2 is the only rule not known to be false, causing an inverse rule to be generated through the same processing sequence and corresponding to waterAmount:quarter & boilTime:short->gasLevel:medium. On return from this recursive invocation of processing of FIG. 6, the process completes, returning for example to its point of invocation at step (716) in FIG. 7 which then returns to its point of invocation step (614) which then continues to step (608).

In the advanced running example, if this level has just processed waterAmount:quarter, would then select waterAmount:half and generate the rule waterAmount:half & boilTime:short->gasLevel:medium. Then, it would process the next and final value, namely waterAmount:full, which would resolve to rule 4, causing the inverse of that rule to be output, i.e. waterAmount:full & boilTime:long->gasLevel:medium. Note that when this condition is true, the previous inverse rule waterAmount:dontCare & boilTime:long->gasLevel:low also matches, meaning that the gasLevel be low or medium under these conditions. Put another way, one may set gasLevel to either low or medium when the waterAmount is full and one wants a long boilTime. Note that it may be acceptable in some applications to have multiple rules match or trigger/fire in response to a given input value combination.

With multiple rules matching, the application may use a separate criterion to select which one to use, for example in this example, selecting low gas as it uses less gas resource, as discussed herein as a cost measure aspect. The goal/constraint ruleset may also be used to eliminate alternatives in the case of overlap/multiple rule matches such as this. In one embodiment, the compiler may report such multiple rule matches and the developer may refine forward mapping to eliminate them.

At that point, this level of FIG. 6 processing completes because all of the values of waterAmount have been handled. Therefore, it returns back to step (716) which then returns to step (614) which then continues to step (608) to process the final gasLevel amount, namely high, using the same sequence of processing, and then terminating.

In step (814), the current rule subset is reported unresolvable. The current rule subset may be unresolvable because one or more consequents have unresolved output parameters. It is called unresolvable because the forward inferencing is unable to resolve it even though all of the inverse input parameters are resolved, that is, have known values. It may also be unresolvable because there are conflicting consequents, for example, one indicating the stove is hot and the other indicating the stove is cold. The process completes, returning for example to its point of invocation at step (716) in FIG. 7 and/or step (614) in FIG. 6. Generation processing may eventually advance to step (702) in FIG. 7 to get the next rule subset, if any. However, any error of the above nature means that the inverse is not fully generated.

FIGS. 6, 7, and 8 complete the illustration of processing to generate an inverse mapping from a given forward mapping and specification of inverse input and output parameters. As mentioned above, an application may require multiple inverse mappings for a given forward mapping as well as having other forward mappings. If so, the processes in FIGS. 6, 7, and 8 are repeated for each inverse mapping.

IMR Inverse Consequent Mappings. In one embodiment, an inverse consequent mapping is generated per IMR based on the sequence of forward inference rules used to determine the IMR. That is, the mapping is the inverse mapping of the last forward inference rule with its inputs being the output values of the inverse consequent mappings of the forward inference rules that resolved the input parameters in this last forward inference rule. And this continues back to the ruleset inputs.

For example, if an IMR indicates the cause in terms of a range of gas settings to cook an egg within some range of time, the inverse function generated for the IMR computes the actual gas setting required to cook an egg within a specific period of time within this range. In this case, there is a function F1 with parameter gasSetting that maps to heat of burner. Then, a function F2 taking a parameter heat that maps to pot water temperature. Then, a function F3 taking a parameter waterTemperature that maps to egg cook time. With these functions, there are the corresponding inverse functions iF1, iF2 and iF3. Therefore the function iF is defined as:
gasSetting=iF(timePeriod)=iF3(iF2(iF1(timePeriod)));
   for the timePeriod in the timeRange. That is, this function is only applicable for a value in this specific range. With an arbitrary value of timePeriod, the parameter value is first mapped to an IMR, which in turn invokes the associated inverse function. In one embodiment, the compiler generates this inverse function to allow determination of the inverse mapping output values.

IMR Output Checking. In one embodiment, the step of generating a new IMR includes checking if this IMR may be combined or partially combined with a previously generated IMR and if so, perform this combining or partially combining instead of independently generating this new IMR. As one case of combining, the generation step includes checking if the consequent to be generated has already been output and if so, using this existing consequent for the new IMR. For instance, if there is a table of consequents to minimize the space when there are complex consequents and multiple antecedents mapping to the same consequent, the new IMR may be modified to map to this existing consequent entry rather than defining a new identical one, thereby reducing the space required to store the inverse mapping.

As another case of this combining, the IMR generation step includes checking if the antecedent may be combined with the antecedent of a previously generated IMR that has this consequent, and if so, modifying the previously generated IMR to subsume the IMR being generated instead of outputting the IMR being generated. For example, if the IMR being generated for a stove specifies “high-gas and no pilot implies set gas to zero” and a previously generated IMR specifies “medium-gas and no pilot implies set gas to zero,” the previously generated IMR is modified to specify “if (medium-gas to high-gas) and no pilot then set gas to zero,” rather than outputting the IMR being generated.

A simple form of antecedent combining is checking if the antecedent/rule antecedent has already been output and if so, checking if the associated IMR has the same consequent as that to be used with the IMR being generated. If so, the new IMR is not generated, being a duplicate of a previously generated IMR.

In one embodiment, the generation step includes checking if there is an overlapping antecedent for a previously generated IMR where that previous IMR has a consequent that is incompatible with that of the IMR being generated. If so, the generation reports the conflicting IMRs. For example, if a previously existing IMR has the consequent of “set gas to zero” and the IMR being generated has an overlapping antecedent with a consequent that is “set gas to low,” the two IMRs conflict for the input values in the overlap of their antecedents and so an error is reported.

Selection of Unresolved Input Parameters. In one embodiment, the selection of the unresolved input parameters at each selection iteration is based in part on the choice that produces and/or is likely to produce the “preferred” partitioning of the current ruleset into ruleset subsets. As referred to herein, preferred may include considerations such as the number of replicated rules, that is, rules in the current ruleset that need to be evaluated in multiple subsets as a result of the newly selected input parameters. One philosophy is to strictly partition the rules into subsets, no replicas. As a heuristic, the next unresolved input parameters may be selected based on minimizing the number of replicas. As another, they may be selected based on maximizing the number of additional premises provided.

Traditional techniques from the methods of generating decision trees may be applied with some modification. For instance, the algorithms used in the decision tree generation algorithm described in “RBDT-1: a New Rule-based Decision Tree Generation Technique” by Amany Abdelhalim, Issa Traore, and Bassam Sayed using information gain may be adapted to select the next unresolved input parameter in the case that the method selects one input parameter at a time.

In general, the above are heuristics that are not guaranteed to produce an optimal processing sequence. However, a suboptimal choice may increase the processing time and/or space requirements. It does not affect the behavior of the output IMR ruleset and has limited impact on the size of the output ruleset, assuming suitable combining of generated rules along the lines described earlier. In addition to the above, the unresolved input parameters may be selected based in part on developer input, knowledge of the domain, and/or empirical information.

Goals. In many application domains, it is useful to identify a “goal” or constraint that needs to be considered in the inverse mapping. This is because a forward mapping normally characterizes the “cause-effect” relationship of a system. For example, it may determine the effect of changing the gas level. Thus, the forward mapping may indicate all the possible effects of causes, but there may be multiple different causes that produce the same effect, often with different costs. Moreover, these cause-effect rules do not have the notion of a goal or objective. For instance, if the goal is to make the burner hotter when it is below the target temperature, the inverse mapping generation is going to generate IMRs for making the burner cooler as well as hotter in the absence of a specified goal. It is also useful to separate out the goals for the forward mapping ruleset because goals may change, without changing these forward mapping rules. These goal or constraint goals can be considered “meta” rules because they are rules on what is permitted or not permitted in the output ruleset.

In one embodiment, one or more goals as referred to herein are specified as a filter on the IMRs that are included in the inverted mapping. That is, if a generated IMR is not consistent with the goals, it is not included in the inverted ruleset and therefore is not part of the inverse mapping. For instance, if a rule increases the delta between the target temperature for the stove burner and the actual temperature, it is inconsistent with the goal of minimizing the delta and thus excluded from the inverse mapping.

In one embodiment, the goals are specified as a goal ruleset that is input to the ruleset compiler. A goal is specified as one or more rules, each having an antecedent in terms of the ruleset parameters. Then, when an IMR is generated, its premises are used to evaluate rules in the goal ruleset. If this evaluation determines that the new IMR is inconsistent with the goals, the new IMR is denied and not included in the inverted ruleset. In one embodiment, a new IMR is discarded if no retain goal rule is satisfied. In one embodiment, a new IMR is discarded if any deny goal rule is satisfied.

In one embodiment, the action or result of a rule in the goal ruleset is one to permit, deny, and/or possibly other outcomes. Continuing the above example, a goal rule may indicate that if the water temperature is below boiling, the burner should not be decreased. Therefore, when an IMR is generated that is contrary to this rule, the new IMR is denied entry into the inverted mapping ruleset, and thus discarded.

In one embodiment, each IMR is considered a potential decision as referred to herein and in U.S. Pat. No. 11,579,614 entitled INCORPORATING RULES INTO COMPLEX AUTOMATED DECISION MAKING, which is incorporated herein by reference for all purposes. The goal ruleset is the filtering of potential decisions (that is, IMRs) before they are included in the inverted ruleset.

When both permit and deny are used, this filter acts similarly to the access control list (ACL) used with computer networking, except in the networking context, it is deciding which packets to admit, not which rules to include in the inverse mapping.

Range-structured Parameters and Clauses. A ruleset parameter may have an associated set of “range constants,” often as part of the definition of the data type of the parameter. A range constant as referred to herein is a named constant specifying a consecutive range of values for the associated type. For example, in an autonomous airplane piloting control domain, the airSpeed parameter may be specified as the type Airspeed, which defines range constants named stopped, low, medium, and high corresponding to the ranges [0,1), [1,60), [60,100) and [100,300) respectively.

With a ruleset variable that has range constants, a clause may be specified in terms of a range constant. For example, with an airspeed parameter, a clause might be specified as “airspeed in Airspeed::medium” meaning it is true if the value of the airspeed parameter is in the range 60 to 99 KPH. Here, the range is interpreted as values that are greater than or equal to the minimum value and strictly less than the maximum value. Therefore, for instance, the range [3,4) designates the value 3 when the input type is an integer value. Thus, the term range as referred to herein includes a single value as a special case.

A ruleset variable whose values are specified in terms of range constants is referred to herein as a range-structured variable. The airspeed example above is a range-structured variable, and more specifically, a range-structured parameter.

A range-structured clause as referred to herein is one that comprises a single ruleset variable being specified as within a range, defined by a range constant associated with this variable. Thus, a range-structured clause is true if the associated variable has a value that is within the range, and false otherwise. For example, the clause “airspeed in Airspeed::medium” is a range-structured clause.

Note that if a rule Ri contains a clause structured as “airspeed not in range0”, it may be replaced by two rules where one has the clause “airspeed in range1” and the other has the clause “airspeed in range2”, where range1 and range2 constitute the complement of range0. Similarly, if a rule Ri contains a clause structured as “airspeed in range1 OR range2” then this may be replaced by two rules where one has the clause “airspeed in range1” and the other has the clause “airspeed in range2.” Therefore, without loss of generality, the autogeneration of the inverted ruleset may assume and/or require that each range-structured clause specifies a single contiguous range of values.

Note that use of range-structured parameters differs from providing an enumeration representing ranges without the ruleset compiler knowing the associated range's limits or thresholds. This is because range constants as referred to herein are allowed to have overlapping ranges. For example, the range constants may be defined as follows: “medium” as [1,60) and “lowMedium” as [1,29), so lowMedium overlaps with the medium range values. Because the ruleset compiler knows the limits or thresholds of the ranges, it may compute output rules, recognizing these overlaps. For example, if one rule has a condition that requires “airspeed::medium” and another that requires “airspeed::lowMedium”, the ruleset compiler may determine that both rules may apply for airspeed values in the range “[1,29)” but only the first rule may apply, depending on the rest of the antecedent, for the airspeed values in the range “[29,60)”. This determination is required and taken into account when generating the inverse mapping.

A clause in the CNF antecedent of a rule that depends on the value of a monotonic function of a single ruleset variable may be structured as a range-structured clause. This is because there may necessarily be a relational operator such as equal, notEqual, lessThan, greaterThan, lessThanOrEqual, and/or greaterThanOrEqual to convert the computed value of the clause to a true or false value. Because the function is monotonic, it may be specified as a range between the minimum value and the maximum value for a range. Therefore, the clause may be converted to a disjunction of range-structured subclauses.

Also, if it is piecewise monotonic, the rule may be replicated for each range where it is monotonic and thus a range-structured subclause, with the single subclause replacing the clause in each replica rule. For example, the antecedent:
(temperature lessThan 50) or (temperature greaterThan 100)
   may be automatically converted into two replica rules with the first replica having the first subclause as its antecedent and the second replica having the second subclause as its antecedent.

Thus with CNF, a range-structured clause is effectively a compact form of disjunction for the case of the clauses of the disjunction that correspond to consecutive values from the minimum value to the maximum value in the range; that is what a range specifies.

A clause that is dependent on a piece-wise continuous function in two or more ruleset variables may be closely approximated by a conjunction of range-structured clauses. A conjunction of K range-structured clauses defines a hyper-rectangle in K-dimension space. A sequence of hyper-rectangles may approximate a piece-wise continuous function, using traditional techniques, in particular standard calculus.

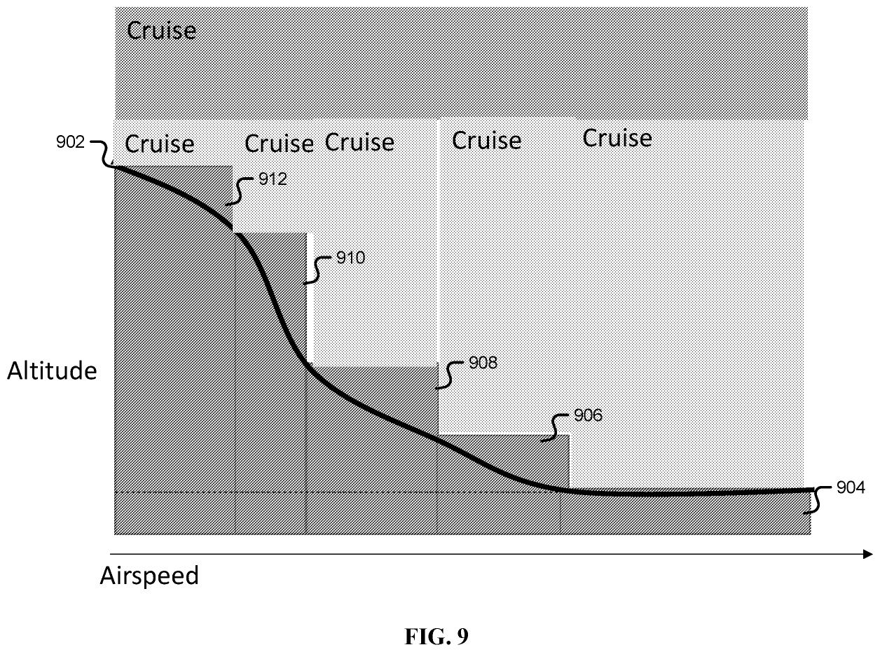

FIG. 9 is an illustration of approximating a piece-wise continuous function. As shown in FIG. 9, the relationship between airspeed and altitude as a continuous function (902) is approximated by the collection of rectangles/hyperrectangles (904), (906), (908), (910), (912) that may be specified, with each rectangle/hyperrectangle represented by a clause in a forward mapping rule. Therefore, if the piece-wise continuous function F (902) is specified along with the required accuracy of approximation, a rule clause using this function F with multiple ruleset variables as parameters may be converted to a collection of forward mapping rules (904), (906), (908), (910), (912) using a range-structure clause that approximates the original ruleset with the required accuracy.

As an alternative specification of ranges, a variable may have an associated set of “threshold” values. Then, a range is defined as between two thresholds, with the smaller threshold value being the minimum and the larger threshold value defining the maximum. For example, if one threshold value is “maxTaxiSpeed=15” and another is “takeoffSpeed=100”, a range constant named “maxTaxiSpeedToTakeoffSpeed” may be automatically generated as [15,100). A range constant between consecutive thresholds may be referred to as a “non-overlapping” range because it does not overlap with other range constants.

As another alternative specification of range to the minimum and maximum values, a range may be specified as a value plus explicit upper and lower “error” bars. That is, the value indicates the ideal value and the error bars indicate how much the input value may deviate from the ideal and still allow the rule to be applicable. That is, the error bars logically indicate how “wrong” the input may be relative to the ideal. The primary difference relative to the earlier specification of range is that the error bar representation allows the error on the higher side to be different from the minimum side of the range for different range constants. That is, the earlier form of range may be interpreted as specifying the ideal value as the value dividing the range into a fixed fraction of the range, usually dividing it in half.

In one embodiment, a range constant is specified with an indication of the value of an ideal point in the range. This indication may be the actual value or the fraction that this ideal value specified as a percentage of the range of the constant. A range-structured ruleset as referred to herein is one in which the antecedent of each rule is a conjunction of range-structured clauses.

The term range constant as referred to herein is used to mean that the minimum and maximum values are constant for the generation of the inverse map. The minimum and maximum values may be changed in a system using the inverse map by updating these values and regenerating the inverse map. Moreover, different inverse maps may be generated from the same forward ruleset and inverse input and output parameters, but with different values for one or more of the range constants. Therefore, an application may effectively change the range constants being used by switching the inverse map(s) it is using.

Autogeneration of An Inverse Mapping for a Ruleset with a Range-structured Parameter. In one embodiment, when the inverse generation method illustrated in FIGS. 6, 7, and 8 selects a range-structured parameter and thus a range-structured clause, the input values for a selected ruleset parameter correspond to the range constants for that parameter, not the actual values. For example, if “temperature” is the selected input parameter and one rule has the clause temperature::cool and another has temperature::warm and another has “dontCare”, that is, the full range, and hot and cold complete the full temperature range (such as −40 to 0, and 200 to infinity), there are 4 non-overlapping ranges. Therefore, the number of rule subsubsets to process as in FIG. 8 is reduced to the number of non-overlapping ranges, which is four, rather than the number of possible input values for this parameter, which may be from minus 40 to infinity. Here, we assume that the rules provide coverage, that is, there is a rule for each range constant. Otherwise, there is at least one input value of this parameter that would cause no rule to be matched.

As above, a range constant may represent individual values, so an enumeration or category input may also be a range-structured parameter. Thus, to further illustrate, if a single input parameter is newly selected and it is an enumeration of 11 values, so there are 11 different input values to consider, there may be a separate check on this input such that its values are one of these values.

To handle overlapping range constants, the generation method recognizes in the generation of rule subsubsets that a rule may be true because it has a clause whose range constant overlaps with one associated with the new input value combination in step (704) of FIG. 7. That is, the rule may be included in a given rule subsubset because of overlap even though the range constant it specifies is different than the one being considered for that rule subsubset. This handling is further complicated if the forward mapping is structured with the restricted inheritance as referred to in U.S. Provisional Patent No. 63/392,057 entitled AUTOMATED GENERATION OF RULES FROM PARTIAL RULE SETS and filed Jul. 25, 2022, and which is incorporated herein by reference for all purposes. This is because there may be derived rules that are partially overriding base rules, thereby providing further overlaps.

It may be assumed and required for each range-structured input parameter, that there is a collection of non-overlapping range constants that completely cover the entire range of that input parameter. That is, for every actual value of the input parameter, it is in the range of one of these non-overlapping range constants. For example, if there is range constant RC1 that is defined as [10,20) and another range constant RC2 defined as [15,25), there are non-overlapping range constants defined as [10,15), [15,20) and [20,25), either part of the input or defined by the compiler as part of its processing. On the latter, the compiler may: collect the minimum and maximum values of all of the range constants, referred to herein as threshold values; sort these threshold values; check for each pair of adjacent threshold values whether the parameter type defines a range constant with these threshold values; and if not, define additional range constants using these two adjacent values. Using the above examples, 10, 15, 20 and 25 are sorted threshold values.

In one embodiment, a modified generation method is used when a range-structured input parameter is selected. The rule subsubsets may be generated for a set of range constants that correspond to the non-overlapping range constants covering the total range of this parameter, factoring out overlap and overriding. That is, rule subsubsets corresponding to this selected input parameter are created, one for each non-overlapping range. For example, if a rule Ri in the input ruleset has the temperature condition as temperature::notCold, meaning it could only be true if the temperature is warm or hot, then the rule Ri appears in both the rule subsubset corresponding to warm as well as the one corresponding to hot, because notCold overlaps with both of these ranges. The compilation process translates a rule that specifies an overlapping range in the newly selected parameter into multiple rules using (sub)range constants that do not overlap, replicating the rules in each subsubset as necessary. For example, if one range is 75 to 300 and another is 200 to 250, the compilation process produces the subranges 75 to 200, 200 to 250 and 250 to 300, and replicates the rules across these subranges such that every rule whose rule antecedent is not known to be false for that subrange appears in the associated rule subset. For instance, in this example, all rules that specify a range constant corresponding to the 75 to 300 range are members of the subsubset associated with each of the three generated subranges. Conversely, if a rule antecedent specifies a non-overlapping range constant such as temperature::hot in its corresponding clause, this rule is known to be false in every rule subsubset generated by selecting this parameter except the one corresponding to the Temperature::hot range constant.

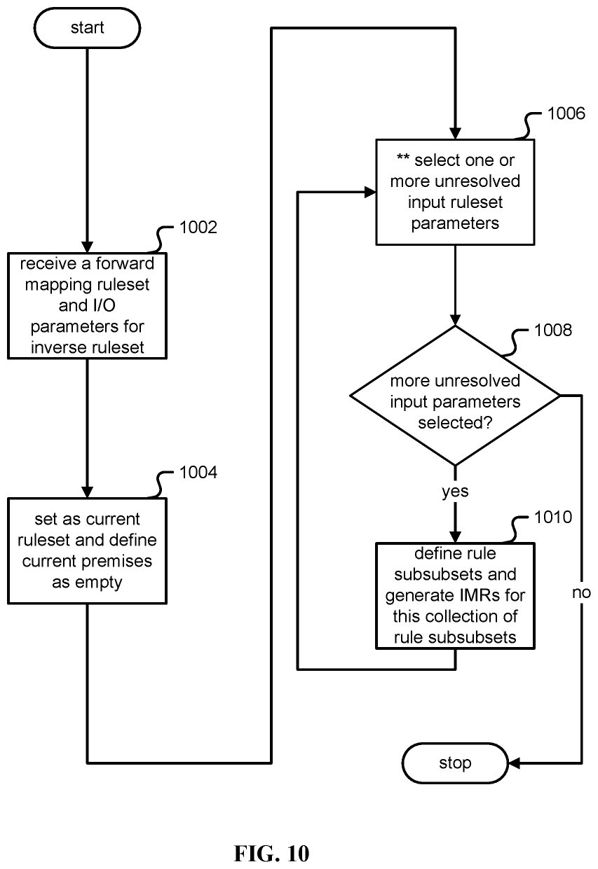

FIG. 10 is a flow diagram illustrating an embodiment of a process for inverse map generation with subset generation. In one embodiment, the process of FIG. 10 is carried out by the system of FIG. 1. In one embodiment, the technique of FIG. 10 is similar to that of FIG. 6 with the addition of (sub)subset generation.

In step (1002), a forward mapping ruleset RS is accepted as input along with a specification of the input and output parameters for the inverse mapping to be generated. The latter output parameters are required to be a subset, or all of, the input ruleset parameters for RS. Similarly, the latter input parameters are required to be the RS output parameters and any RS input parameters that are not specified as the inverse ruleset output parameters. Returning to the running example, the output result parameter is gasLevel, which is an input to the operand ruleset.

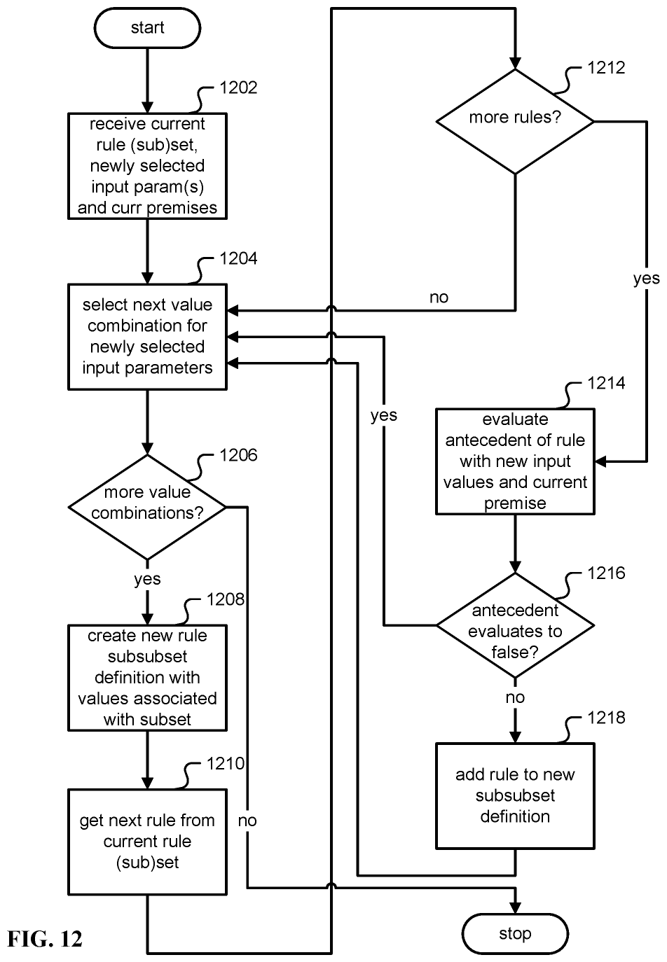

In step (1004), the forward mapping ruleset is specified as the current rule subset and the current premises set is empty. In step (1006), designated in FIG. 10 by the ** symbol for cross-referencing in FIG. 12, one or more unresolved inverse mapping input parameters are selected. In one embodiment, a single additional unresolved parameter is selected in this step. Again, in the running example, assume that gasLevel is selected as this unresolved parameter.

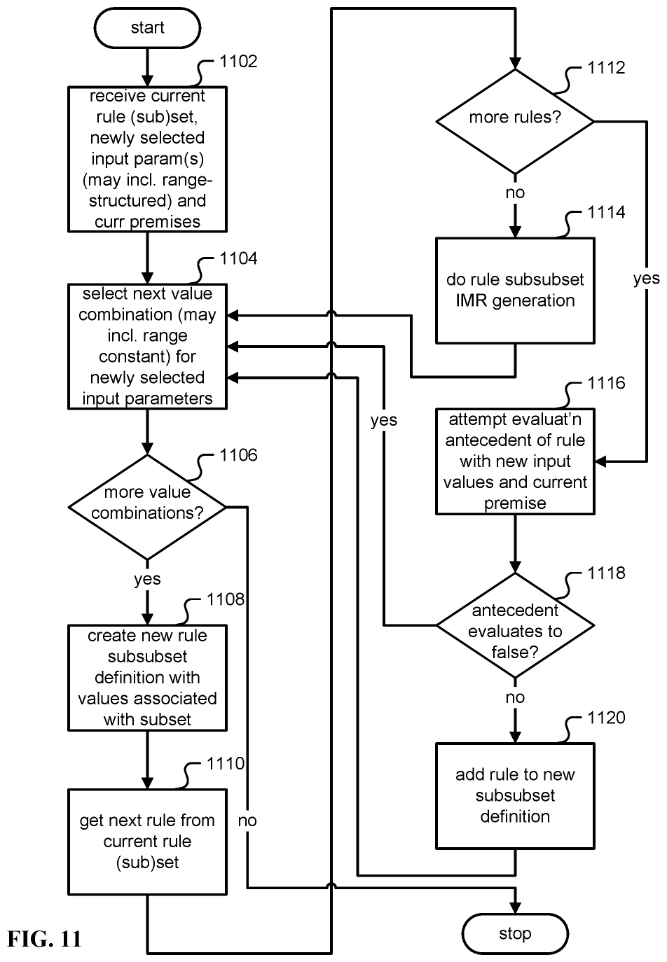

In step (1008), in the event there are no more unresolved inverse mapping input parameters selected, or alternately put, in step (1006) there are no additional input parameters selected, control is transferred to completion of the process; otherwise, control is transferred to step (1010). In step (1010), rule subsubsets are defined and/or subsubsets are generated for the newly selected input parameters, including the invocation of further processing in FIG. 11. In the example, on the first iteration the range constant low is selected for the gasLevel; it would then select medium as the next range constant to consider, and then the final range constant of high. The range constant for low may correspond to a gasLevel of 20 to up to 40 percent, for example low=[20, 40). Therefore, any gasLevel in percentage between these two minimum and maximum values for this range constant cause this subcondition to be true. Similarly, medium as a range constant may correspond to a gasLevel of 40 up to 70 percent and high may correspond to a gaslevel of 70 to 100 percent. Therefore, the actual gasLevel input may take on any value between 20 and 100 percent yet the rules only have to handle these three range constants.

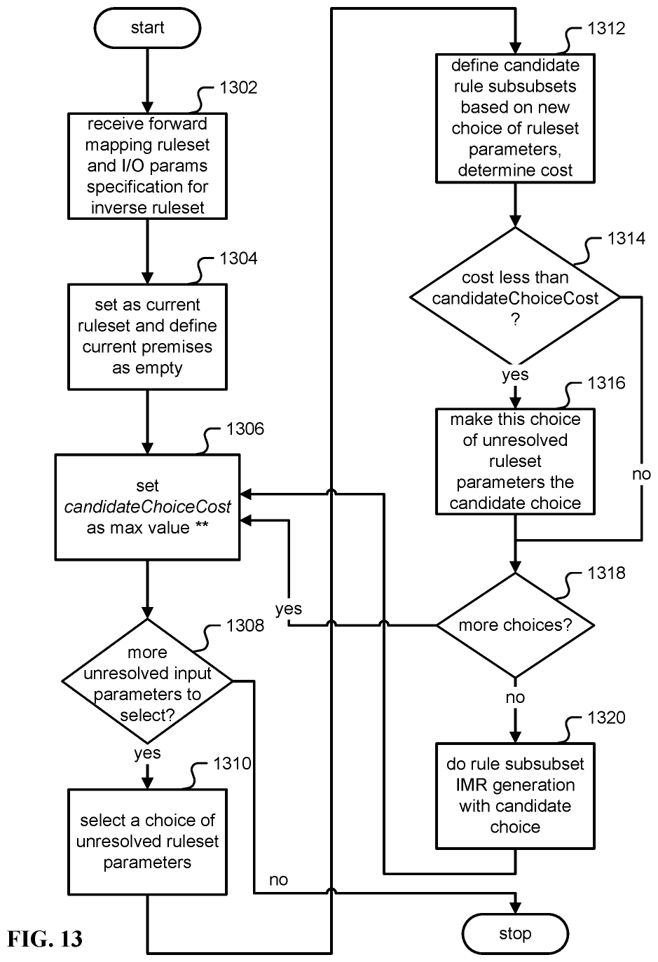

Note that step (1006) is recursively invoked as shown later in FIG. 13. When this step is recursively invoked, the rule subset considered a “current rule subset” is the subset of the forward mapping rules that are not determined to be false for a “current” set of premises.

FIG. 11 is a flow diagram illustrating an embodiment of a process for rule subset definition. In one embodiment, the process of FIG. 11 is part of step (1010) in FIG. 10 and/or is carried out by the system of FIG. 1.

FIG. 11 generates definitions or explicit representations of subsubsets for each possible non-overlapping input value combination for the newly selected input parameters. FIG. 11 also shows the process of IMR generation using the “current rule (sub)set,” “current premises,” and the newly selected input value combination. For a selected input parameter that is range-structured, the value is a range constant for that input parameter, rather than the actual value of the input. Returning to the running example, if gasLevel is range-structured, the “values” it selects are the range constants low, medium and high, not every possible numeric percentage that the gasLevel can be set at.

In step (1102), this current rule (sub)set, current premises, and newly selected input value combination are received, for example as shown in the flow of FIG. 10. In this step (1102), a new “premises” set is created from the current premises and the new input values in this input value combination; that is, the ruleset parameter whose values are now specified and antecedent clauses that are known to be true or false. As shown in FIG. 11, the process handles the case where one or more of the input parameters are range-structured, yet not necessarily all input parameters are range-structured.

In the running example, on the first invocation of this processing, the gasLevel in the premise is set to indicate low as the current assumed or premised range constant for that input.

For each subsubset, a rule from the input subset is included if its range constant for this input parameter is equal to or overlaps with the non-overlapping range constant associated with this subsubset. After a subsubset is fully defined or generated, the processing specified in FIG. 8 is invoked to output the IMRs, as is similar to that shown in FIGS. 6-8.

In step (1104), the next value combination is selected for the newly selected input parameters. Note that that a value selected is a range constant for a parameter when it is a range-structured parameter. In step (1106), in the event that there are more value combinations, control is transferred to step (1108); otherwise the process completes.

In step (1108), an empty new rule subsubset definition is created. In step (1110), iteration over the rules in the current subset commences and/or is continued. The next unprocessed rule in the current rule (sub)set is retrieved for processing. In step (1112), in the event there is another unprocessed rule, control is transferred to step (1116); otherwise control is transferred to step (1114).

In step (1116), an attempt is made to evaluate this rule antecedent using the known ruleset variable values based on the current premises and the input value combination associated with this new rule subsubset definition. Note that the evaluation may succeed even without all the ruleset variable values resolved in some cases. For instance, if a clause of the CNF antecedent of a rule is gasLevel:medium and the range constant for the gasLevel is low as indicated for the first invocation, the entire antecedent is known to be false even if other ruleset variables in the antecedent are not resolved.

In step (1118), in the event the rule does not evaluate to false, either because it evaluates to true or may not be evaluated because of unresolved ruleset variables, control is transferred to step (1120); otherwise control is transferred to step (1104). In the running example, the only rules known to be false in step (1118) are rules 9 and 10, because their antecedent is made false by the gasLevel:low, based on the current premise.

In step (1120) the rule is included in the current rule subsubset and control is transferred to step (1104). In step (1114) (where it was established in step (1112) that there are no more unprocessed rules), IMR generation is performed for this rule subsubset, as detailed in FIG. 8. In the example, on this first invocation of this processing, this subsubset consists of rules 1 through 8 inclusive.

FIG. 12 is a flow diagram illustrating an embodiment of a process for rule subset collection definition. In one embodiment, the process of FIG. 12 is part of step (1010) in FIG. 10 and/or is carried out by the system of FIG. 1.

In one embodiment, the collection of subsubsets is fully generated as shown in FIG. 12 and then processing of FIG. 8 is invoked by separately iterating over these subsubsets and invoking FIG. 8 processing on each of these subsubsets. Thus, the difference between FIGS. 11 and 12 is that FIG. 11 generates the IMRs for each rule subsubset as it proceeds, by contrast with FIG. 12 generating all the rule subsubsets for the current premises and selected input parameters first and then generating IMRs for each generated rule subsubset as a separate iteration.

Thus, in step (1202), this current rule (sub)set, current premises, and newly selected input value combination are received, for example as shown in the flow of FIG. 10. In this step (1202), a new “premises” set is created from the current premises and the new input values in this input value combination; that is, the ruleset parameter whose values are now specified and antecedent clauses that are known to be true or false. In the running example, on the first invocation of this processing, the gasLevel in the premise is set to indicate low as the current assumed or premised value for that input.

In step (1204), the next value combination is selected for the newly selected input parameters. In step (1206), in the event that there are more value combinations, control is transferred to step (1208); otherwise the process completes.

In step (1208), an empty new rule subsubset definition is created. In step (1210), iteration over the rules in the current subset commences and/or is continued. The next unprocessed rule in the current rule (sub)set is retrieved for processing. In step (1212), in the event there is another unprocessed rule, control is transferred to step (1214); otherwise control is transferred to step (1204).

In step (1214), an attempt is made to evaluate this rule antecedent using the known ruleset variable values based on the current premises and the input value combination associated with this new rule subsubset definition. Note that the evaluation may succeed even without all the ruleset variable values resolved in some cases. For instance, if a clause of the CNF antecedent of a rule is gasLevel:medium and the input value for the gasLevel is low as indicated for the first invocation, the entire antecedent is known to be false even if other ruleset variables in the antecedent are not resolved.

In step (1216), in the event the rule does not evaluate to false, either because it evaluates to true or may not be evaluated because of unresolved ruleset variables, control is transferred to step (1218); otherwise control is transferred to step (1204). In step (1218), the rule is included in the current rule subsubset and control is transferred to step (1204). In the running example, the only rules known to be false in step (1216) are rules 9 and 10, because their antecedent is made false by the gasLevel:low, based on the current premise.

In one embodiment, the subsubsets are fully generated as in FIG. 12 for multiple different choices of selection of unresolved input parameters and a cost is estimated with each of the choices, and then selection with the lowest cost is selected, and then processing of FIG. 8 is invoked by iterating over these subsubsets and invoking FIG. 8 processing on each of these subsubsets.

FIG. 13 is a flow diagram illustrating an embodiment of a process for inverse map generation with optimized input parameter selection. In one embodiment, the process of FIG. 13 is carried out by the system of FIG. 1. In one embodiment, the technique of FIG. 13 is similar to that of FIG. 10 with the optimized input parameter selection.

In step (1302), a forward mapping ruleset RS is accepted as input along with a specification of the input and output parameters for the inverse mapping to be generated. The latter output parameters are required to be a subset, or all of, the input ruleset parameters for RS. Similarly, the latter input parameters are required to be the RS output parameters and any RS input parameters that are not specified as the inverse ruleset output parameters.

In step (1304), the forward mapping ruleset is specified as the current rule subset and the current premises set is empty. In step (1306), designated in FIG. 13 by the ** symbol for cross-referencing, the current candidate cost, candidateChoiceCost is set as the maximum.

In step (1308), in the event there are no more unresolved inverse mapping input parameters selected, control is transferred to completion of the process; otherwise, control is transferred to step (1310). In step (1310), a choice of unresolved ruleset parameters is selected. In step (1312), one or more candidate rule subsubsets are defined based on the new choice of ruleset parameters and a cost is determined.

In step (1314), in the event that the cost determined in step (1312) is less than the current value of candidateChoiceCost, control is transferred to step (1316); otherwise control is transferred to step (1318). In step (1316), as the cost is lower, the selected choice of step (1310) is made the candidate choice of unresolved ruleset parameters.

In step (1318), in the event there are more choices, control is transferred to step (1306); otherwise control is transferred to step (1320). In step (1320), IMR generation is performed for the candidate choice, as detailed in FIG. 8.

Thus, when the technique of FIG. 13 is invoked by step (1010) of FIG. 10, it iterates over choices of unresolved input parameters to select, generating a collection of rule subsubsets as in FIG. 12 for each choice, finding the lowest cost choice, and then invokes the processing of FIG. 8 with this choice. The generation of candidate rule subsubsets enables computing the cost for each choice, such as the replication cost described herein.

As an example of a cost metric, the cost may be the total number of replicas of rules required for the subsubsets. For example with a gas stove, if the gas pressure gasLevel input is selected, there may be a large number of cause-effect rules that require it to be normal and only one for when it is zero. Therefore, picking gas pressure results in no extra replication because the “zero” rule goes in the “zero” subsubset and all the other rules go into the “normal” subsubset. On the other hand, if the waterAmount is picked, there may be cause-effect rules that have dontCare for this input, so there is a large amount of replication. The extra replication requires more computation time to generate the inverse mapping. It may also result in a larger inverse mapping implementation and thus a more costly one, unless there is sophisticated merging of inverse rules performed.

Range-Structured Parameter Processing. In one embodiment, any input parameter that has an overlapping range is handled as a range-structured parameter. This is possible because every individual value of such an input parameter may be treated as a range constant.

In one embodiment, a forward mapping output parameter RP may be specified as outputting a range constant for that parameter, rather than a specific value. Then, if an inverse mapping specifies RP as an input, the clause:
RP in RPCi
   is generated in the antecedent to an IMR. This clause requires RP to have a value in range constant RPCi.

If a forward input parameter is range-structured and is selected as an output of the inverse mapping, the output value is a range constant rather than a specific value for this input parameter. For example, RP is selected as an output parameter of the inverse mapping and appears in a range-structured clause:
RP in RPCi
   then, an IMR may be generated with the output value of RPCi.

If the input ruleset is entirely range-structured, this revised generation of FIG. 10 and FIG. 11 may be applied to all the parameters. If the input ruleset is partially range-structured, meaning that only some of the input parameters are range-structured, the above generation method may be applied to those input parameters that are range-structured, and the remaining input parameters may be handled as necessary by the first and more general automatic generation method.

Range-structured parameters may be used to specify enumeration parameters or categories by associating a unique numeric value with each constant. For instance, red, blue and yellow may be associated with the values 1, 2 and 3 and represented by the ranges [1,2), [2,3) and [3,4). Hierarchical categories may also be mapped onto ranges by using high-order bits of a numeric designation to indicate a parent category and low-order bits to indicate the subcategory to the parent. These numeric mapping techniques are traditional.

Using the running example above from FIGS. 6-8 or FIGS. 10-12, a first step is translating names for subcondition values to ranges. For example, boilTime:quick is [1,3) minutes, boilTime:short is [3,5) minutes, and boilTime:long is [5,100) minutes. Ranges may be used in combining rules, for example rule 2, burnerTemperature: hot & waterAmount:quarter->boilTime:short and rule 3 burnerTemperature: hot & waterAmount:half->boilTime:short may be combined by having a range corresponding to quarter to half full of water, burnerTemperature: hot & waterAmount:[quarter, half]->boilTime:short. Similarly, rules 6 and 7 may be combined by having a range corresponding to half to full of water, burnerTemperature: veryHot & waterAmount:[half, full]->boilTime:short.

With logically continuous inputs such as temperature, distance, speed, and so on, different rules may be applicable as particular threshold values. For example, water behaves differently once the temperature reaches the threshold of boiling. These thresholds in rules define ranges, allowing the use of range-structured ruleset variables. Continuous mappings may be approximated with the use of discrete ranges, as described earlier. Therefore, in applications in which such an approximation is sufficient, a range-structure ruleset may be used. Also, other techniques such as simulation as described below may be used to refine a range output from an inverse mapping to provide a more accurate output value to use. In one embodiment, an input ruleset is converted to a range-structure ruleset, if not already in this form, using in part the techniques taught herein.

Inverse Ruleset Operator. In one embodiment, the ruleset inverse operation is implemented in a ruleset compiler as one of the ruleset operators that may be applied to “partial” rulesets. As referred to herein, partial means that the rule in such a set is not necessarily fully specified as required by the application, for example, for an autonomous aircraft, a partial rule may be:
if climbing then raise the elevators.
   There are different degrees of raising the elevators and different categories of climb, from gradual to rapid. Therefore, this rule is partial in the sense of not being specific enough in rule condition or rule action. It is also partial in that it is missing necessary aspects in its condition, such as the current vertical speed and current altitude.

An observation made herein is that a rule may be viewed from a set perspective. In particular, a rule condition may effectively define a set of scenarios, namely those in which the rule condition is true. That is, a rule condition may be interpreted as designating set membership, namely for a given rule R, the set of all input scenarios for which the rule condition for R evaluates to true. Thus, it may be considered a set membership predicate.

Similarly, an action normally designates a set of specific actions because, for instance, there are parameters to the action. For example in autonomous aircraft, an action may be to increase airspeed by 30 percent. Thus, the actual action on the throttle may depend on various factors including the airspeed, current pitch, altitude, and other factors. Therefore, a rule may be viewed as a membership implication between one set, the rule condition set, such as a set of input scenarios matching a rule condition, and a second set, the action set, such as a set of actions. That is, if the current inputs are in the rule condition set of this rule, the action is in the action set of the rule. Therefore, rules may be computed on by set operations on these two sets. In particular, the rule condition computation may be effectively based on set operations. However, set operations on rules may require rule-specific considerations in order to preserve the rule semantics and be practical.

Also, in practice, a ruleset may be developed as a set. It may not be feasible to deal with individual rules, one at a time, to provide an adequate solution, as a system may require a set of rules that are complete, consistent, and unambiguous. These are properties of the ruleset as a whole and may not be determined by examining individual rules independently. Set operations are thus applied to a set of rules but also with rule-specific aspects to the set operations in order to preserve rule semantics. Practically, these ruleset operations may be operations on sets of sets. These operations may therefore be qualified as “ruleset intersection,” “ruleset union,” and so on.

Rulesets may be regarded as “partial” in the sense that there are additional aspects that may be added to rule conditions and actions to make the ruleset more specific or more complete. For example, an autonomous aircraft control rule set may consider flight operations as well as traffic in the area. However, the ruleset may be missing inputs on other factors that may influence the flying, such as the fault status of the aircraft and rules that determine whether it is safe to take-off or if in flight, whether to continue, for specific faults. This view is consistent with set theory where any set may be regarded as a subset. However, herein, the term subset is deprecated as it may not recognize the rule structure to sets of interest. It may poorly suggest that a ruleset is missing rules wherein more commonly, a partial rule set is missing subconditions.

A ruleset may be automatically compiled from applicable partial rules in partial rule sets that are inputs (that is operands) to a ruleset operation. These operations include ruleset intersection, union, difference, complement, and cross-product and in various combinations of those:

Ruleset Intersection. A ruleset intersection may be an operation or operator taking two or more partial rule sets as operands and compiled by forming a rule for each combination of partial rules, one from each of the intersecting partial rule sets. As referred to herein, two rules intersect if their action sets intersect and their rule condition sets intersect. Thus, ruleset intersection is the pair-wise intersection of rules in the constituent partial rule sets of the intersection. When the rule action of one partial rule PRi intersects with the rule action PRj, the conjunctive condition applies to the intersection of action sets.

For example, if a partial rule from one set applies to flying, and a partial from another set applies to high flying, the conjunctive rule condition applies to just high-flying. However, if there is also a rule in one of the operand rulesets that applies when flying but not flying high, intersection also includes the modified version of this rule, modified to indicate “not flying high.”

As an illustration, in the single case of specific rule actions, in generating a rule for intersection for action AA from two partial rule tables PRT0 and PRT1, if partial rule PRi has action AA and has a condition PRiC that is true for the set of scenarios in set A and partial rule PRj has the same action AA and has a condition PRjC that is true for the set of scenarios in set B, then the rule for the intersection has a rule condition that corresponds to the intersection of sets A and B, that is PRiC AND PRjC.

In one embodiment, partial rule sets are not ambiguous and the ruleset intersection is compiled between partial rules with intersecting action sets. This is more efficient than considering intersections between all combinations of partial rules. It is sufficient with partial rule sets that are not ambiguous. This is because rule conditions do not intersect unless action sets intersect. This can be shown because if PRi and PRj are on different actions, the conjunction of these rule conditions would be unsatisfiable and/or non-intersecting, or else there would be an input scenario for PRi that matches the rule condition PRj, or vice versa. Otherwise, there would be no input scenario in the conjunction. If that is the case, then the partial rule set PRT0 containing PRTi is ambiguous. That is, an input scenario would match two different actions. As an improvement, considering partial rules with intersecting action sets is more efficient and results in fewer rules that are not satisfiable; that is, the rule condition may not be true.

In one embodiment, at each decision point at run-time, that is rule evaluation stage, each rule produced by ruleset intersection may be evaluated by separately evaluating the rule condition of each partial rule set that is an operand to the intersection and then treating the rule as matched if every one of these operand evaluation results are true. Using the example above to illustrate, the evaluation would evaluate PRiC and PRjC and treat the actual rule condition as true only if both evaluate to true.

In one embodiment, a ruleset is compiled into a more efficient form by combining and simplifying the rule condition that results from ruleset operations. For example, if PRiC and PRjC contain a common subexpression co, the intersection rule condition can be simplified by identifying this common expression co and evaluating it once, rather than twice, once in the context of PRiC and then again in the context of PRjC.

Performing set operations on arbitrary rule condition expressions may lead to expensive rule condition evaluation without the combining and simplifying taught above yet it may not be necessarily possible/understandable in the general case how to simplify the compiled rule condition other than combining them with logical operations. For example, if RC0 and RC1 are two arbitrary rule conditions, and RC0 contains a condition (f(x)<y), it is not generally feasible to simplify the rule condition for the intersection of these two rule conditions. Therefore, the run-time rule evaluation can evaluate the rule condition as RC0 & & RC1. Moreover, it may not even be feasible to determine if this expression is satisfiable so it may be fully evaluated at each rule evaluation time even though it may not evaluate to true.

Identified Subconditions. Use of identified subconditions may aid with this issue. In one embodiment, a rule condition is composed of a plurality of identified subconditions with this identification being specified across these partial rule sets. For example, currentAirspeedModerate may be the name of an identified subcondition. This identification has the same meaning in each of the partial rules in the collection of partial rule sets. In particular, if currentAirspeedModerate is an identified subcondition in two partial rulesets in an expression, this subcondition has the same meaning in both.

In one embodiment, a representation of partial rules is as a table with a labelled column per identified subcondition as well as a column labelled action or decision. A rule is represented by a row in this table. In that row, the rule condition is realized as the conjunction of the subcondition columns and the rule action is designated by the row entry in the decision/action column(s). A column may be designated as storing an arbitrary rule condition expression. A disjunction in a rule condition may be handled in this table format by multiple rows, one for each subexpression of the disjunction. Therefore, all rule conditions may be represented in this table format. Equivalently, the table representation may be pivoted so that each column corresponds to a rule and each row corresponds to a subcondition or action.

In one embodiment, a rule generated by intersection has a rule condition that contains the intersection of the identified subconditions of each of the partial rules that are operands to this intersection. Therefore, each identified subcondition is evaluated once even though it occurs in each of these partial rules. For instance, if there are partial rule tables PRT0, PRT1 and PRT2, the rule condition for an application rule may be generated for rule action RA to include a subcondition identified by SCi based, at least in part, on the subcondition SCi in the selected partial rules in each of PRT0, PRT1 and PRT2. For example, if SCi is currentAirspeedModerate, meaning this is required to be true, in each of the partial rules, then the rule condition of the generated rule includes currentAirspeedModerate. That is, the row corresponding to this intersection may have the value true in the table entry corresponding to its row and the column labelled currentAirspeedModerate.

In one embodiment, an identified subcondition can be qualified, for example, currentAirspeed:moderate or currentAirspeed greater than X. In general, a qualifier is defined herein as an expression that can be evaluated during rule evaluation.

In one embodiment, a qualified identified subcondition for a compiled rule is determined by selecting the identified subcondition qualifier that is the intersection of the same identified subcondition in each of the applicable partial rules. Here, subcondition qualifier intersection as referred to herein means a qualifier that is true if and only if true for each of the same-identified subconditions in the applicable partial rules. This intersection may be determined by the conjunction of these same-identified subconditions and creating a qualifier for this conjunction. In one embodiment, the conjunction can be used directly. However, in some cases, there is a qualifier that is known to correspond to the intersection. For example, if one partial rule has the current airspeed subcondition qualified as lowToMedium and another is qualified as mediumToHigh, the generated rule has the current airspeed subcondition qualifier identified as medium, because that is common to both of the partial rules. In the case that a partial rule specifies “don't care” for a particular identified subcondition, this partial rule has no effect on the intersection because any result for this subcondition is effectively true for it.

In one embodiment, the ruleset intersection is compiled as the intersection of rules in the constituent partial rule sets where the intersection of individual rules is computed as the intersection of the identified subconditions in the rule conditions which is computed as the intersection of the qualifiers on these identified subconditions.

In one embodiment, one or more qualifiers for an identified subcondition are defined as a range of values for a particular value. For example, the medium qualifier used earlier may correspond to an airspeed between 200 mph and 300 mph. For these subconditions, the intersection of two subconditions may be computed efficiently as the range corresponding to the overlap between these two ranges. Moreover, it may be efficient to determine if the intersection is not satisfiable; that is indicated by the range being empty. For instance, if one partial rule in the intersection specifies airspeed less than 100, and another specifies airspeed greater than 100, the intersection is simply null or empty.

In one embodiment with identified subconditions where the qualifiers refer to ranges, an application rule set with N identified subconditions can be regarded as classifying regions of an N-dimensional space, where each dimension corresponds to a subcondition and each qualifier associated with this subcondition refers to a range in that dimension. A rule condition effectively defines an N-dimensional hyper-rectangle by the conjunction of its subcondition qualifiers. The application rule condition may be viewed as being generated by geometric operations on the regions defined by the applicable partial rule conditions. In particular, the generated rule for intersection has a condition that corresponds to the geometric intersection of the regions defined by the rule condition of each of the applicable partial rules.

In one embodiment, the conjunctive inclusion of a partial rule set may designate the complement of the rule conditions in a given partial rule set. Here, the applicable rules are recognized as those specifying the complement of the rule action of the rule being compiled. Then, a condition from a partial rule is incorporated in the generated rule as the complement of its condition. This complement mechanism allows a “prohibitive” ruleset to be used in determining a constructive application rule set. That is, as referred to herein, the generated rule has a rule condition that indicates when a given action can be performed as well as when it is allowed to be performed, the latter based on it not being prohibited. Note that the conversion from prohibited to its complement may produce multiple ranges for a given subcondition, thereby requiring multiple generated rules. For example, if some action is prohibited between 1000 and 2000 feet of altitude, there is a rule generated for the altitude being below 1000 feet and one generated for the altitude being above 2000 feet.

In one embodiment, a partial rule in a partial rule set can specify as its rule action a range or plurality of actions. One form is the negation of an action, which is interpreted as the complement of this action in the set of actions.

Applicable Partial Rules. In one embodiment, a partial rule for a given application rule being generated is identified as applicable by having an action that is relevant to the action of application rule. In the simple case, the action of the partial rule matches that action for the application rule being generated. In a more sophisticated case, a partial rule is applicable if its action is a category of actions that includes the action for the application rule being generated. One case of “same category” is the application action being derived from the action in the partial rule. In another case, a partial rule is applicable if its action is a subaction of the action for the application rule being generated. A subaction as referred to herein is normally one of the steps required to perform this top-level action.

In one embodiment, a partial rule may specify a condition that is a sequence of subconditions that correspond to subactions. For an example, in autonomous aircraft, a rule may say that turning left is the subaction of banking to the left by angling the ailerons, arising the elevators slightly, increasing the throttle, and then reducing the banking back to level. That is, a rule that satisfies these subaction subconditions implies it is performing the associated action, and rather than indicating an action in the future, it indicates that the action has been completed if the rule condition holds. This form of partial rule allows the compiler to recognize that a partial rule that is associated with a subaction is applicable to the application rule being generated.

In one embodiment, a given application action is a restricted case of another action, possibly by a partial rule. That is, from an object-oriented programming standpoint, the restricted action is derived from the base action. For example, a partial rule may apply to the climb action which may have specific application actions of slow climb, moderate climb, and rapid climb. The slow climb, moderate climb, and rapid climb are regarded as derived from the base climb action. The rule compilation then treats the base rule as applicable when generating rules for one of the derived actions, that is, the base rule action set includes as subsets the derived action sets. As referred to herein, the rules for derived actions inherit the conditions associated with their base rules. If a partial rule set includes a partial rule for a base action as well as a derived action, the rule compilation uses the rules with the most derived action that is equal to or a base for the current application action being considered.

In one embodiment, actions are categorically identified, similar to identified rule subconditions. For example, an action may be elevator:neutral designating that the aircraft elevators may be positioned in the neutral position.

In one embodiment, the rule action may be specified as a plurality of identified actions, that is a vector of identified actions. For example, a decision may be a vector such as [elevator:neutral, throttle:80percent, ailerons:neutral].

Note that segmenting partial rule sets by actions or categories of actions is feasible but is primarily an optimization to reduce the size of a partial rule set. For example, rather than having a partial rule set that contains all the partial rules for the dynamics of flying, this partial rule set may be partitioned into partial rule subsets for each different action, such as climbing, ascending, cruising, and so forth.

Union. A ruleset may be specified as the union of two or more partial rule sets. In particular, the union rule set of partial rule sets A, B, and C is one as referred to herein which contains rule Rif it occurs in at least one of A, B, and C, for each such rule R. The set of identified subconditions is also the union of those in the constituent partial rule sets. The action vectors of each of these partial rule sets are assumed to have identified actions, with a common meaning to an action identification across the partial rule sets, similar to identified subconditions.

The result for a union is a vector of results from each of the constituent partial rule sets. Thus, a union of A, B, and C as above produces a result vector [a, b, c] capturing one result from each of its constituents. That is, the union set has a union action vector. Rules from different operand rulesets may specify the same action. In this case, a union may provide additional rule conditions for the same resulting action. For example, if one partial rule set PR0 has the rule RC1->A0 and another partial rule set PR1 has the rule RC2->A0, then the union of these two rule sets includes both these rules. Note that the union may produce a rule set that is ambiguous, that is, produces different decision results on the same input scenario even if the operand rulesets are not ambiguous.

In one embodiment, a prohibitive ruleset may be generated from multiple prohibitive partial rule sets. Here, the generated rule conditions use the union of conditions rather than intersection. This is because the prohibition applies when any of the partial rule conditions are true. This contrasts with constructive rule generation where it is necessary to take the intersection of the partial rule conditions.

The union operation allows the development of partial rule sets for separate phases of a controlled systems operation. As an example, there may be a partial rule set for taxiing an autonomous aircraft as well as one for flying and one for landing. In this example, there may be no overlaps in rules because the taxiing ruleset applies when altitude is essentially zero and the airspeed low, the flying one applies for proper airspeed and the landing gear up, and the landing ruleset applies when the landing gear is down. It also allows for the separate development of rules for the control of separate subsystems, one partial rule set for each. A ruleset union operation may automatically combine these component partial rule sets into an application rule set that handles all of the systems. As an example in autonomous aircraft, there may be separate partial rule sets for each of elevator, throttle and ailerons. A ruleset union operation automatically combines these component partial rule sets into an application rule set that handles all three of these subsystems. In each of these cases, developing the partial rule set for each phase or subsystem separately is simpler than directly developing the combined rule set directly. As an improvement, performing rule evaluation on the combined rule set is more efficient in space and processing than performing separate rule evaluations on each of the partial rule sets. Therefore, development efficiency does not compromise deployment/production efficiency or vice versa.

Ruleset Cartesian Product. A ruleset Cartesian product as referred to herein is produced logically by producing a rule for each combination of elements selected from each of the operand rulesets. For example, if RC0->RA0 is a rule in operand set x and RC1->RA1 is a rule in operand set Y to the Cartesian product operator, the resulting ruleset contains the rule
RC0->RA0, RC1->RA1
   meaning that if RC0 is true, then RA0 is taken, and if RC1 is true then RA1 is taken, and both actions are taken if both conditions are true. With identified actions, if two such rules refer to the same action, this same action is taken if either or both of the associated conditions are true.

One use of the ruleset Cartesian product is having a partial rule set for each identified, qualified subcondition of interest, with each such ruleset containing a rule with a rule condition comprising the single subcondition for each qualifier of that subcondition. For example, if one of the identified subconditions is temperature and it has the qualifiers cold, warm and hot, there is a rule with rule condition temperature::cold, one with rule condition temperature::warm and one with rule condition temperature::hot. Then, if each of these rules has the same action, such as unknown, the Cartesian product is a ruleset that completely covers all possible input conditions for a ruleset that uses these subconditions of interest.

Ruleset Complement. A complement of a ruleset ARS is a unary ruleset operation referred to herein as producing the ruleset that contains, for each rule R in ARS, a resulting rule that has as a rule condition that is the negation of that of R and a rule action that is the complement of the rule action of R. The complement of a rule action RA comprises all the potential actions that are not RA, or not in RA if RA is a set of actions. If the rule action is a vector of identified actions, the complement rule action is the complement for each identified action.

In one embodiment, a ruleset is automatically simplified in some cases when there are multiple rules with the same rule condition that correspond to most of the possible actions in the range of potential actions. For example, if the possible actions are RA0, RA1 and RA2 and there are rules:

RC0 −> !RA0
RC0 −> !RA1

where the ! symbol denotes negation or complement, then the ruleset can be simplified by replacing these two rules with the single rule

!RC0 −> RA2

In one embodiment, the ruleset complement provides multiple rules for a given rule R in the operand ruleset to represent the complement of the rule action in R. Building on the previous example, if the operand ruleset contains:

!RC0 −> RA2

then the complement is represented as:

RC0 −> !RA0
RC0 −> !RA1

that is a plurality of rules whose actions together constitute the complement of RA2. In this case, the ruleset complement of the complement produces the original ruleset as expected.

There is also a ruleset relative complement that produces a ruleset that contains all the rules in a first ruleset that are not in the second ruleset operand. One use of this ruleset relative complement is to have the first set be a cross-product ruleset that covers the entire possible input domain. Then, the ruleset relative complement of some ruleset RS is non-empty if RS is not complete for the domain.

In one embodiment with identified, qualified subconditions, the cross-product or ruleset Cartesian product ruleset may contain a rule with a rule condition for every possible combination of qualifiers for the identified subconditions, as described above. As a simple example, if there is an airspeed identified subcondition with qualifiers: fast, moderate, and slow, and an altitude identified subcondition with qualifiers: low, medium, and high, the cross-product on these qualifiers produces a rule with a rule condition for each of fast-low, fast-medium, fast-high, moderate-low, moderate-medium, moderate-high, slow-low, slow-medium, and slow-high with the rule action being a fixed unknown indication. For example, using the earlier example, if ARS did not contain rules with rule condition for fast-high and slow-low, the resulting partial ruleset of the relative complement of the Cartesian product ruleset would contain two rules, namely:

unknown <− fast and high
unknown <− slow and low

The resulting partial rule set contains rules that match scenarios that are not matched by any of the rules in ARS.

Ruleset Difference. The ruleset difference is referred to herein as the same as set-theoretic difference, namely as the ruleset complement of the ruleset intersection of the operands. Therefore, it may be compiled as compiling this intersection and then producing the complement as described earlier.

Ruleset Mirroring. In some systems, there is a symmetry between conditions and rules. For example, in controlling an aircraft, banking left and banking right are mirror operations. Also, the subcondition of traffic to the left is the mirror of traffic to the right.

In one embodiment, a partial rule set may define, as referred to herein, a subcondition to be mirror of another subcondition, a mirror subcondition, and an action as the mirror of an existing action, referred to herein as a mirror action. Then, a partial ruleset can be mirrored by this mirror to produce a mirror ruleset of the first operand ruleset. For an example in autonomous aircraft, suppose that rightClearTraffic is the mirror subcondition of leftClearTraffic, and rightBankIntent is the mirror subcondition of leftBankIntent, and bankRight action is the mirror action to a bankLeft action. Then, if the first operand ruleset contains the rule:
bankLeft<-airspeedAdequate AND leftClearTraffic
   then the mirror ruleset may contain the rule:
bankRight<-airspeedAdequate AND rightClearTraffic

That is, a rule is produced automatically by the compiler where the action is the mirror action of the original rule and the rule condition is produced by substituting a mirror subcondition for each subcondition with a mirror in the original rule condition, and just using the original subcondition for subcondition SC if there is no mirror subcondition for SC. The application ruleset may be produced by taking the union of the first operand ruleset and its mirror. Thus, in this example, the first operand ruleset deals with actions to the left and straight ahead. The mirror operation adds in the rules for going to the right. As with the other ruleset operations, a rule produced by mirroring may be overridden by directly specified rules in the top-level ruleset or another operand ruleset. Thus, mirroring does not have to result in an exact mirror set of rules.

Using this mechanism, the developer of a system that has this symmetry may specify or generate a much smaller partial ruleset for one side as an improvement in design time, run time, and computing resource efficiency, and then use the mirroring to complete the ruleset automatically.

In one embodiment, a mirrored rule is produced for any rule in the first operand set that has a mirrored subcondition with the action designated as the original action plus a mirror prefix or suffix. For example, the above example would produce the rule
bankLeft-mirror<-airspeedAdequate AND rightClearTraffic
   rather than designating the action as bankRight. Thus, there is no need to specify the mirror action designation, which is an improvement in design time efficiency.

In one embodiment, the mirroring is specified in a ruleset that indicates/makes the mirroring conditional on other subconditions. For example with an aircraft, there is some symmetry to climbing and descending, but primarily in the case airspeed is above some threshold. By adding the airspeed subcondition, the mirroring is applied within this threshold. With the provision of extra subconditions for mirroring to match and the overriding mechanism, ruleset mirroring requires an actual compiler mechanism that incorporates knowledge of the rule structure. It may not be implemented directly by a simple textual substitution.

In one embodiment, the mirroring mechanism can be used to produce an inverted ruleset. For example, if an autonomous aircraft requires the ability to fly upside down as well as right side up, there may be a need for an inverted ruleset. In particular, in the inverted position, banking left requires the opposite actions to the normal upright position. That is the ailerons are positioned in the opposite way as are the elevator and rudder. In this case, the mirroring rules can specify both a mirror and inversion mapping. For example, a bankRight normally requires lowering the left aileron and raising the right aileron, whereas the inverted rule requires raising the left aileron and lowering the right aileron. Using the mirroring mechanism in the case of inverted flight, the rules for inverted flight may be produced automatically from the ruleset for upright flight with the inverted rules possibly labelled as inverted-bankRight, and so on, thereby allowing the union of the upright and inverted rulesets to produce a single application ruleset automatically from one that deals with maneuvers to the left during upright flight. This is an improvement because it requires less design time, run time, and computing resources.

In general, the mirroring mechanism provides a conditional remapping of rule subconditions to produce a revised ruleset that may then be either used separately by the application or combined into another ruleset using it as an operand to the other ruleset operations. The mirroring and inverse examples illustrate merely two uses of this conditional remapping mechanism.

Prioritized Union, Prioritized Rulesets and Inheritance. In one embodiment, a prioritized union ruleset operation as referred to herein produces a prioritized ruleset by assigning a priority to each of the rules in each operand ruleset as part of adding each to the resulting ruleset. If an operand RS0 to a prioritized ruleset union is already a prioritized ruleset, the priority assigned to the rules from RS0 in the result prioritized ruleset is based in part on the priority assigned to RS0 by the prioritized union. For example, a prioritized ruleset that is the result set of a prioritized union of prioritized rulesets RS0 and RS1 is
prioritizedResultSet=RS0 prioritized-union RS1
   and has every rule from RS0 assigned a higher priority than any rule from RS1. This is because the priority assigned to a ruleset in this example is implicit in the order of the operands.

A prioritized union may explicitly specify the priority associated with each of its operands, for example
prioritizedResultSet=A(100) prioritized-union B(1000)
   Alternatively, the priority may be implicit in the order of operands to the prioritized union as in the earlier example.

In one embodiment, a ruleset RS may be directly specified with a priority for each rule, as provided traditionally in some ordered or prioritized rule systems. This is equivalent to producing the ruleset from a prioritized union of a list of rulesets that contains in total all the rules in RS and in which the prioritized union assigns those same priorities.

Traditionally in a prioritized ruleset, if two or more rules match on a given input, the rules out of that matching set that are activated are chosen based on priority. For example, in a simple case, if rule Ri and Rj both match and Ri is priority 3 and Rj is priority 5, using the traditional computing model of a lower number being a higher priority, Ri is activated and the matching to Rj is ignored. Effectively, Ri overrides rule Rj. The priority of a rule may be explicitly specified in each rule in a ruleset. Alternatively, the priority of a rule is implicit in the order in which the rule occurs in the ruleset. Therefore, the matching is equivalent to the matching in network access control systems and order-based rule conflict resolution in traditional general rule-based systems. This prioritized ruleset is technically a rule list, rather than a set, because it is ordered. In this case, it is common for a rule earlier in the list to be viewed as higher priority than one later in the list.

The prioritized union ruleset operation assigns priority to rules across an entire ruleset in one operation rather than requiring the priority to be set in each individual rule, as in traditional systems. It also allows prioritized rulesets to be combined and have the individual rule priority of each rule in an operand ruleset to be automatically adjusted, that is recomputed, according to the priorities assigned by the prioritized union to each operand ruleset, as each such rule is added to the result ruleset. Finally, it allows for what are otherwise conflicting rulesets to be combined by union relying on priority-based conflict resolution while still optionally indicating conflicts among rules with the same priority.

A prioritized ruleset union may be used to achieve a similar functionality to inheritance with rulesets. Here, the term inheritance as referred to herein is similar to the inheritance mechanism as used in object-oriented programming (OOP). In particular, a derived ruleset as referred to herein is produced as the prioritized union of the base ruleset BRS and one or more higher priority extending rulesets ERSi that specify the derived rules. Thus, any rule ER in an ERSi that matches on some input to the same condition as a rule BR in BRS overrides the action of BR when there is a match of the inputs in this overlap region. Also, any rule in ERS that does not overlap with those in BRS extends BRS with this additional rule, consistent with the behavior of derivation. By structuring the derived rules as more specific than the base rules, following the normal OOP inheritance approach, the priority may be used to achieve the traditional specificity criteria for rule conflict resolution, but with the improvement of better computing time/resource efficiency of comparing priorities. In one embodiment of a deriving prioritized union ruleset operator, a rule whose rule condition overlaps with a base rule condition is automatically assigned a higher priority than the base rule with which it overlaps.

In one embodiment, a ruleset inheritance operation is realized as a prioritized ruleset union in which a derived rule is automatically assigned a higher priority than its base rule. Also, optionally the compiler ensures that the condition of a derived rule matches a subset of the scenarios that the condition of the base rule matches. Note that ruleset inheritance differs in certain aspects from normal object type inheritance. This is because the result set may be produced from multiple extending rulesets, that is, there may be multiple derived rulesets in a single inheritance operation. Also, ruleset inheritance may be implemented as per-rule inheritance across all the rules in the operand partial rulesets. Furthermore, ruleset inheritance produces a single result ruleset whereas with traditional OOP inheritance, each derived type is a different type being generated.

In one embodiment, priority is indicated by inheritance. In particular, a derived rule is indicated as having a base rule, which implicitly indicates that the base rule is lower priority. That is, the inheritance between rules is indicated and those indications implicitly indicate their priority. Because a derived rule condition set is strictly a subset of the conditions matched by the base rule, relative priority between inheritance-related rules is all that is needed. That is, a rule may not override a rule unless it is a base rule of R, directly or indirectly.

In one embodiment, other ruleset operations herein are provided that support prioritized rulesets. In particular, ruleset intersection may treat two rules from its operand rulesets as intersecting if the two rules are the same priority. A ruleset complement operation may invert the rules in the operand ruleset separately for each priority as it adds these rules in the result ruleset. The prioritized Cartesian product may adjust the priorities of the rules from the operand rulesets as it generates the individual rule combinations. For example, the priority of all the rules from the first operand ruleset may be adjusted to be higher than those of the second operand ruleset. This adjustment typically matters when there is overlap, that is intersection, between the operand rulesets.

In the case of automated inverse mapping, the forward mapping ruleset may be implemented using, for example, intersection and restrictive inheritance from more basic partial rulesets and then the inverse operator may be applied to generate the inverse mapping as required by the application. For example, the forward mapping may be used to generate visual attributes of different types of objects from their characteristics, and then this forward mapping may be inverted to provide classification of objects based on these visual attributes.

Cost-qualified Mapping. In one embodiment, a forward mapping rule is specified with a cost. For example, the cost may indicate the elapsed time between the rule antecedent becoming true and the consequent computed or achieved; that is, the cost in time.

In one embodiment, the generation of the inverted mapping computes and outputs the cost for output, considering the inverse input parameter values specified. For example, if the throttle setting is changed to a specified amount, the elapsed time output indicates the expected time until the controlled system/vehicle has a state that matches the associated effect; that is, if cause C happens, how long in time it is before effect E takes place.

To compute this cost for an IMR, inversion processing computes the inference path for each inferred premise/inference as it takes place and the cost of inference to this premise as referred to herein. When an inference is based on two or more premises, the cost of the inference path to that point is the maximum of the inference paths to each of these premises. Thus, the maximum of the cost across each of these input premises plus the cost of the next inference. Then, when an IMR is generated, the cost associated with the IMR is the maximum of the inference paths that lead to this IMR premise.

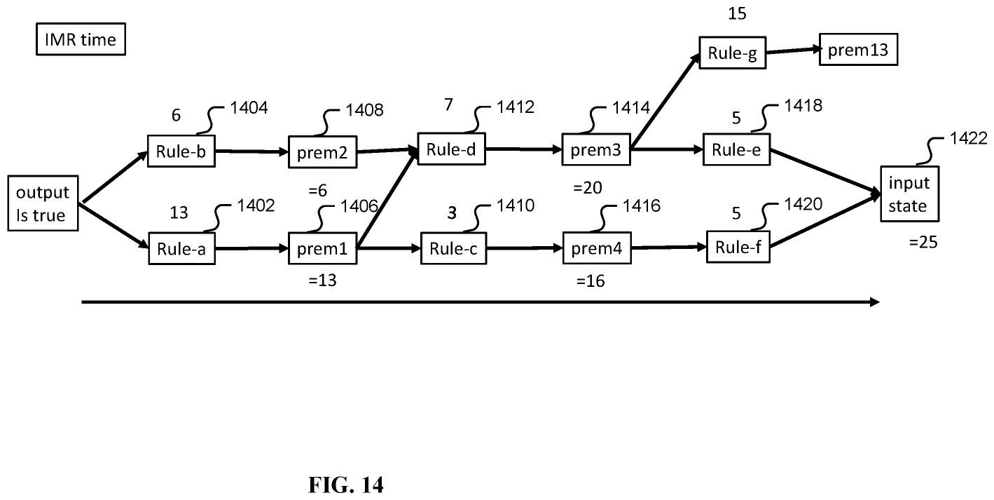

FIG. 14 is an illustration of cost calculation as an elapsed time calculation. In FIG. 14, Rule-a and Rule-b are triggered by the forward “cause” parameter value being assumed or true. The elapsed time for a rule is listed above the rule. The elapsed time to a premise starting from 0 at the setting of the cause parameter is listed below with a preceding “=” sign. Thus, the IMR elapsed time is the sum of the times of the longest inference path from input to the output, after tracing each path and summing the costs.

In the example of FIG. 14, Rule-a (1402) incurs 13 units of elapsed time to cause premise1 (1406) to be true while Rule-b (1404) incurs 6 to cause premise2 (1408) to be true. Similarly, Rule-c (1410) incurs 3 to cause premise4 (1416) to be true while Rule-d (1412) incurs 7 to cause premise3 (1414) to be true. The elapsed time to premise3 (1414) tracing either a first inference path via Rule-a (1402) is 13+7=20, or a second inference path via Rule-b (1404) is 6+7=13, so the longest inference path via Rule-a (1402) has an elapsed time=20 to premise3 (1414). Similarly, both Rule-e (1418) and Rule-f (1420) incur 5 to the input state (1422), so tracing either an inference path via Rule-e (1418) is 20+5=25, or an inference path via Rule-f (1420) is 16+5=21, so the final elapsed time for the forward mapping is 25 units of elapsed time, and so the inverse is the same.

That is, if the forward mapping indicates it takes 25 units of time to get from cause to effect under particular conditions, the inverse mapping indicates effect was/is achieved under these conditions at 25 units of time after the cause occurred, or in the future case, will occur 25 units of time after the cause happens.

Note that, if a given inferred premise is not used to produce the result, its elapsed time cost is not relevant so is not included. For example, in FIG. 14, the inference elapsed time for premise13 through Rule-g is 15, but because premise13 is not used by the output, this cost is not considered. In general, if the output clause being true triggers a rule that directly provides the output, the costs associated with other rules that are triggered and do not provide an output are not relevant.

In one embodiment, the elapsed time cost is one unit for each inference rule, and the cost of the IMR is computed as a maximum length inference path from the inverse inputs to the output. In one embodiment, each rule has an associated time value. In one embodiment, the cost may be computed as the total cost of the inference rules used to achieve the output. For example, in an electricity-powered robot, the cost may be the total energy cost of taking the action that is provided by the inverse mapping. In this case, the resulting energy cost for a particular inverse mapping is the sum of these inference rules.

In one embodiment, the ruleset may have a multiplicity of costs associated with rules, for example, time and fuel costs, and these costs may be computed in one of several different ways. In one embodiment, a goal mechanism may select the least cost IMR that is activated by a particular input value combination that is consistent with other goal specifications for this inverse mapping, where a value may be a range constant in the case of a range-structured input parameter. In particular, upon generation of a new IMR, the goal mechanism checks if there is already an IMR with the same inputs and if so, if it is lower cost. If it is lower cost, the new IMR replaces the previous IMR.

Inverting a Rule-Specified Simulation. A computer simulation of a system may be specified by a ruleset in which, at each timestep, the rules are evaluated and those whose antecedents are true, indicate the values that the simulation state is to take on at a later timestep. For example, an increase in the throttle of a vehicle may cause a rule to trigger that implies in its consequent an increase in the torque at the drive wheels, implying an increase in speed at a later timestep. As described in the previous section, the rule may indicate a time cost for this effect to take place. In effect, this forward mapping is a mapping from the current simulation state to a future state.

With this simulation ruleset as the forwarding mapping, as described herein, this may produce an inverse mapping that indicates an input that caused the current state of the simulation, treating the other aspects of the state as “context parameters,” as above.

This same inverse mapping may be used to determine the input required to achieve a given desired state based on this rule-based simulation. Using the above example to illustrate, the inverse mapping with output parameter throttleDelta and input parameter desiredSpeed may be used to determine the change in throttle required to achieve the desired speed.

In one embodiment, range-structured rules and outputs are used, and a range-based forward mapping rule is specified to provide an approximate simulation. In this case, the forward mapping rules specify ranges for simulation state attributes in the simulated future. For example, an increase in the gas knob position on a gas stove that is in the moderate range causes, given other context parameter values, a temperature increase rate that is in the slight Increase range. That is, the simulation only provides an indication that the temperature increase rate is not decreased, nor is it increased more than slight, rather a specific numeric value of temperature increase. Thus, as described herein, an inverse mapping may be generated from these forward mapping rules that determines the appropriate range for setting an input to achieve a desired result in a given range, but without indicating the specific value for this input.

In some applications, a range constant for the result of the inverse mapping is sufficient. For example, with a gas stove, the output range may indicate a setting of off, low, medium and high as range constants for the setting. The inverse mapping may indicate one of these range constants. In this case, the input to the stove may simply be a fixed setting associated with the range constant, because the setting may not be critical and may be corrected over time. If a more precise setting is required, a detailed simulation of the stove and the environment may be used with values in the range to determine the precise setting of the gas level to achieve the desired temperature. In this case, the inverse mapping serves to limit the range of parameter values to be simulated.

Concurrent Decision Tree Generation. In one embodiment, the inverse mapping is generated directly as a decision tree with each leaf specifying the output function or value. In particular, there is a current partial decision tree that is initialized as null. Then, the first selected set of unresolved input parameters determines the decision id or label on the root node. If this selected set contains one input parameter, the node maps the value of that input parameter to one of its child nodes, as is traditional. To illustrate using the earlier example of an enumeration or category parameter with 11 values, there would be 11 child nodes, one for each value. If this set contains multiple input parameters, the root node may be expanded to a decision subtree with the root mapping the first selected input parameter to a child node and each child mapping a second input parameter to a child of it and so on. Alternatively, the root node may map each value combination for the multiple selected input parameters to the associated child directly.

The step of generating a new IMR is then modified to locate the node in the current decision tree that corresponds to the currently selected input parameters and modify it to indicate it is a leaf node mapping to the consequent for the IMR. If a node does not exist on the path indicated by these currently resolved input parameters and values for this IMR, the node is created as a child of the closest parent with the appropriate mapping to this child, repeated as necessary to handle the IMR antecedent. For instance, for a partial tree with a root node associated with the input gasPresssure, if the new IMR has the antecedent gasPressure:normal and pilotLight:on and gasKnob:increased, if the current partial tree root has a child of the value normal that is associated with pilotLight input and it has a child node for the on value that is associated with the input gasKnob, the consequent is added as a leaf node in the partial tree, for the value of increased for this child leaf node. If any of the intermediate nodes do not exist when this IMR is generated, they are added to the decision tree prior to adding this leaf node. Note that this sequence differs from normal decision tree construction. This is because of the mappings of consequent to antecedent and antecedent clauses to consequent, that is, leaf nodes, as was illustrated in FIG. 4.

The heuristic optimizations, adapted from traditional decision tree generation as described earlier, may be applied as part of this generation to reduce the lookup and/or space cost of the decision tree. That is, the selection of the next unresolved parameters at each iteration may be selected to reduce the height or size of the decision tree being generated.

In the case of a forward map containing strictly range-structured antecedent clauses, the mapping of input parameter value to child node may be implemented by mapping according to the thresholds between ranges, as described earlier. Directly generating the inverted ruleset as a decision tree may gain an improvement in the reduction of the computing space and processing cost, when compared to first generating a full or table representation of the inverted ruleset.

Embedding Forward Mapping Rules in an Object Model. In one embodiment, the forward mapping rules are embedded in an object model. This is similar to that used in U.S. Pat. No. 10,761,921 entitled AUTOMATIC ROOT CAUSE ANALYSIS USING TERNARY FAULT SCENARIO REPRESENTATION, which is incorporated herein by reference for all purposes. An improvement over a given embodiment is that it is applied to more general causes than just faults, and allowing for non-Boolean values. For example, the gas stove example may be represented in the compiler as a stove object that contains one or more component objects, such as Burners, Knobs, Valves, GasLines, Pots, PilotLight, and so forth. A Knob object may have an attribute that is its setting. Changing its setting “propagates” to the Valve object to which it is attached, to cause it to open or close, which propagates to the flow of gas in the GasLine it is connected to, which propagates to the Burner to which it is connected. This propagation as referred to herein is a cause-effect relationship and is logically equivalent to rule implication.

The compiler in this embodiment may then directly translate these propagations to rules by treating the immediate source “symptom” of the propagation as the antecedent and the “symptom” to which it propagates as the consequent. The symptom as referred to herein as a Boolean expression is a clause as the term is used in this disclosure. For example, a symptom may be stove:burner3:temperature notHot. The object and attribute context provided by the object embedding may be a naming convenience.

After this translation to a ruleset as specified as referred to herein, the compiler may then use the techniques described herein to invert this mapping to produce a mapping that maps from effect to cause(s).

U.S. Pat. No. 10,761,921 discloses a method for automatic root cause analysis where the key innovation is the use of dontCare. As an improvement, the techniques described herein may be used for automatic root cause analysis along the same lines by restricting input parameters to Boolean symptoms of faults, having the forward mapping rules map from root cause faults, directly or indirectly, to observed symptoms and representing false, true, unknown as consecutive numeric values, with dontCare as an overlapping range of these values. In this case, the inverse mapping then maps from input symptoms to root cause faults, matching the functionality of the automatic root cause identification method described in U.S. Pat. No. 10,761,921.

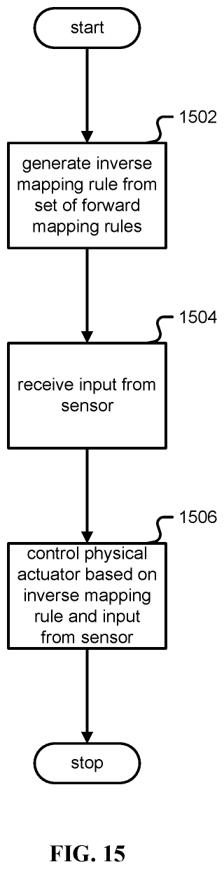

FIG. 15 is a flow diagram illustrating an embodiment of a process for generating an inverse mapping from a forward mapping specified by a ruleset. In one embodiment, the process of FIG. 15 is carried out by the system of FIG. 1.

In step (1502), an inverse mapping rule is generated from a set of forward mapping rules. In one embodiment, the set of forward mapping rules is part of a forward mapping ruleset and the inverse mapping rule is part of an inverse mapping ruleset. In one embodiment, the forward mapping ruleset is a range-structured ruleset. As referred to herein, a range-structured ruleset includes one in which the antecedent of each rule is a conjunction of range-structured clauses. In one embodiment, the set of forward mapping rules associated with the given input parameter comprises a range-structured clause.

In one embodiment, the set of forward mapping rules specifies a behavior of a physical system simulation. As referred to herein, a behavior of a physical simulation system includes the change in the simulation state that represents the state of the simulated physical system over time during the execution of the simulation for the state. In one embodiment, the set of forward mapping rules is embedded in an object model specification. In one embodiment, the set of forward mapping rules relates causes to effects in an engineered system.

In one embodiment, a further step (not shown in FIG. 15) comprises generating a comprehensive inverse mapping ruleset at least in part by generating all inverse mapping rules for each forward mapping rule of the forward mapping ruleset. In one embodiment, a comprehensive inverse mapping ruleset as referred to herein is one that has all the inverse mapping rules that may be generated from the input ruleset. Note that the use of a goal ruleset to eliminate rules does not compromise such a definition of a comprehensive inverse mapping ruleset. Note also that a goal ruleset only eliminates an IMR after the rule is generated, so it still generates a comprehensive inverse mapping ruleset by this definition. Thus, a comprehensive inverse mapping ruleset is generated from a plurality of IMRs to form a ruleset before application execution is taking place. That is, unlike backward chaining, an IMR is not generated during application execution as needed. Thus, a comprehensive inverse mapping ruleset is sufficient for the application to function using the pregenerated IMRs without further generation of IMRs.

The inverse mapping is well-defined for a given forward mapping ruleset and inverse mapping definition in terms of inputs and outputs. In one embodiment, a further step (not shown in FIG. 15) comprises transforming the set of forward mapping rules to a conjunctive normal form (CNF).

In one embodiment, a further step (not shown in FIG. 15) comprises determining the inverse mapping rule is consistent with a goal. In one embodiment, this comprises determining the inverse mapping rule matches an allow goal rule. In one embodiment, an allow goal rule implies a technique that treats every rule that is not “allowed” to be by default denied. In one embodiment, this comprises determining the inverse mapping rule does not match a deny goal rule. In one embodiment, a deny goal rule implies a technique that treats every rule that is not “denied” to be by default allowed.

In step (1504), input is received from a sensor. A sensor as referred to herein is anything that detects, measures, and/or responds to a physical property and/or physical record. Examples of a sensor include without limitation: a camera, pressure sensor, speed sensor, fluid level sensor, load sensor, position sensor, torque sensor, center of gravity sensor, feedback sensor, airspeed sensor, vertical speed sensor, altimeter, cabin pressure sensor, temperature sensor, variable transformer sensors, force sensor, vibration sensor, magnetometer, gyroscope, data monitoring sensor, telemetry sensor, ultrasonic sensor, infrared sensor, speedometer, tachometer, tension sensor, microphone, a mechanical sensor, an electromagnetic sensor, an electronic sensor, a solid state sensor, an optical sensor, a company stock exchange (including a sensor to sense a stock price value), and/or a doctor's senses such as their eyes/nose/hands. In one embodiment, the set of forward mapping rules relates the input from the sensor to a sensor data interpretation.

In step (1506), a physical actuator is controlled based at least in part on the inverse mapping rule and the input from the sensor. A physical actuator as referred to herein is anything that causes a physical device to (further) act, display, and/or operate. Examples of an actuator include without limitation: machine controls, aileron control, elevator control, stabilator control, rudder control, wing flaps control, leading edge devices, spoiler control, trim systems, autopilot toggle, ejection seat activator, accelerator, brake control, steering control, parking brake control, lights toggle, communications control, robot arms, LED display, database store, magnetic/optical storage, electromagnetic wave, stock purchase order, and/or a medical diagnosis record.

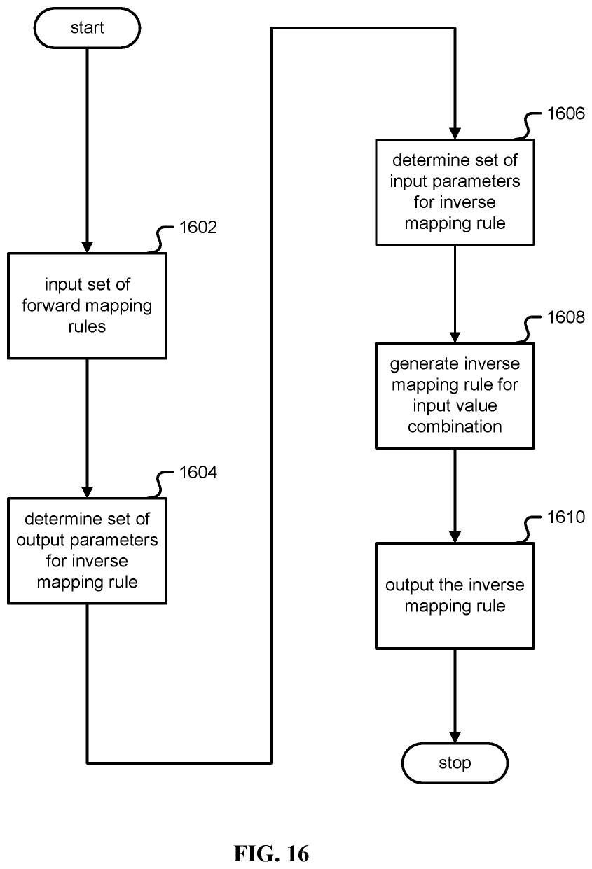

FIG. 16 is a flow diagram illustrating an embodiment of a process for generating an inverse mapping from a set of forward mapping rules. In one embodiment, the process of FIG. 16 is carried out by the system of FIG. 1. In one embodiment, the process of FIG. 16 is included in step (1502) of FIG. 15.

In step (1602), a set of forward mapping rules is input. In step (1604), a set of output parameters for an inverse mapping rule is determined based at least in part on limiting the set of output parameters to be a subset of input parameters for the set of forward mapping rules.

In one embodiment, a given input parameter for the set of forward mapping rules is discretized. As referred to herein, a discretized input parameter includes ranged and enumerated variable types. In one embodiment, a given output parameter for the set of forward mapping rules is discretized.

In step (1606), a set of input parameters for the inverse mapping rule is determined based at least in part on limiting the set of input parameters to be: output parameters and input parameters of the set of forward mapping rules. In one embodiment, an input parameter is both an input and an output so is passed through from input to output; and/or an input parameter is an output parameter in the inverse.

In step (1608), the inverse mapping rule for an input value combination is generated. In one embodiment, a forward mapping produces a default value(s) if the input value combination does not otherwise match any forward mapping rules. In one embodiment, a realization produces output for the case of an input value combination, as the alternative means there is no indication if it completed the forward mapping in this case or is still working on it.

In one embodiment, in the case that the input value combination does not match any forward mapping rules the forward mapping output is dontKnow, so the inverse is also dontKnow as the antecedent of one or more rules with the consequent of each such rule mapping to one of the input combinations that do not match in the forward mapping ruleset.

In one embodiment, generating the inverse mapping rule comprises selecting a given parameter based on an estimated cost of a given rule associated with the given parameter. In one embodiment, generating the inverse mapping rule comprises resolving input parameters before resolving context parameters.

In step (1610), the inverse mapping rule is output. In one embodiment, outputting the inverse mapping rule comprises outputting a comprehensive inverse mapping ruleset. In one embodiment, the inverse mapping rule is output into a decision tree representation.

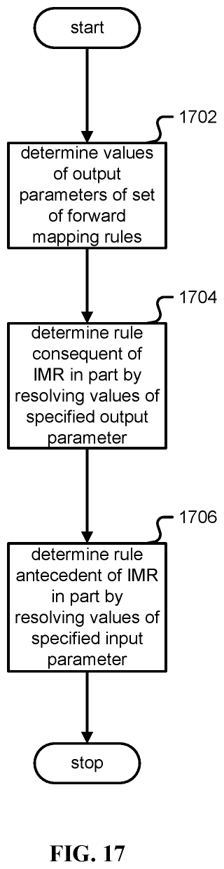

FIG. 17 is a flow diagram illustrating an embodiment of a process for generating an inverse mapping rule for an input value combination. In one embodiment, the process of FIG. 17 is carried out by the system of FIG. 1. In one embodiment, the process of FIG. 17 is included in step (1608) of FIG. 16.

An input value combination that does not produce any true antecedent evaluates to false. In one embodiment, such useless rules are removed from the inverse mapping. Input value combinations that do not evaluate to false are processed starting with step (1702). As referred to herein, a valid input value combination is an input value combination that does not evaluate to false.

In step (1702), values of output parameters of the set of forward mapping rules are determined based at least in part on the input value combination and the set of forward mapping rules. In one embodiment, the set of forward mapping rules is not “comprehensive,” such that a forward mapping does not contain “all possible” rules. In this case for some possible input value combinations that match no rules, the rule evaluator may evaluate the ruleset to a default value(s). In one embodiment, determining values of output parameters of the set of forward mapping rules is entirely based on the input value combination and the set of forward mapping rules.

In step (1704), a rule consequent of the inverse mapping rule is determined at least in part by resolving values of a specified output parameter from the set of output parameters for the inverse mapping rule from the input value combination.

In step (1706), a rule antecedent of the inverse mapping rule is determined at least in part by resolving values of a specified input parameter from the set of input parameters for the inverse mapping rule from the determined values of output parameters of the set of forward mapping rules.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
generating an inverse mapping rule from a set of forward mapping rules, comprising:
inputting the set of forward mapping rules;
determining a set of output parameters for the inverse mapping rule based at least in part on limiting the set of output parameters to be a subset of parameters for the set of forward mapping rules;
determining a set of input parameters for the inverse mapping rule based at least in part on limiting the set of input parameters to be: output parameters and input parameters of the set of forward mapping rules;
generating the inverse mapping rule for an input value combination, based at least in part on:
determining values of output parameters of the set of forward mapping rules based at least in part on the input value combination and the set of forward mapping rules;
determining a rule consequent of the inverse mapping rule at least in part by resolving values of a specified output parameter from the set of output parameters for the inverse mapping rule from the input value combination; and
determining a rule antecedent of the inverse mapping rule at least in part by resolving values of a specified input parameter from the set of input parameters for the inverse mapping rule from the determined values of output parameters of the set of forward mapping rules; and
outputting the inverse mapping rule;
receiving input from a sensor; and
controlling a physical actuator based at least in part on the inverse mapping rule and the input from the sensor.

2. The method of claim 1, wherein the set of forward mapping rules is part of a forward mapping ruleset and the inverse mapping rule is part of an inverse mapping ruleset.

3. The method of claim 1, wherein determining values of output parameters of the set of forward mapping rules is entirely based on the input value combination and the set of forward mapping rules.

4. The method of claim 2, further comprising generating a comprehensive inverse mapping ruleset at least in part by generating all inverse mapping rules for each forward mapping rule of the forward mapping ruleset.

5. The method of claim 4, wherein outputting the inverse mapping rule comprises outputting the comprehensive inverse mapping ruleset.

6. The method of claim 2, wherein the forward mapping ruleset is a range-structured ruleset.

7. The method of claim 1, wherein a given input parameter for the set of forward mapping rules is discretized.

8. The method of claim 1, wherein a given input parameter has an associated set of range constants.

9. The method of claim 1, wherein a given input parameter is a range-structured parameter.

10. The method of claim 9, wherein the set of forward mapping rules associated with the given input parameter comprises a range-structured clause.

11. The method of claim 1, wherein a given output parameter for the set of forward mapping rules is discretized.

12. The method of claim 1, further comprising transforming the set of forward mapping rules to conjunctive normal form (CNF).

13. The method of claim 1, further comprising determining the inverse mapping rule is consistent with a goal.

14. The method of claim 1, further comprising determining the inverse mapping rule matches an allow goal rule.

15. The method of claim 1, further comprising determining the inverse mapping rule does not match a deny goal rule.

16. The method of claim 1, wherein generating the inverse mapping rule comprises selecting a given parameter based on an estimated cost of a given rule associated with the given parameter.

17. The method of claim 1, wherein generating the inverse mapping rule comprises resolving forward mapping parameters that are mapped to inverse output parameters before resolving context parameters.

18. The method of claim 1, wherein the set of forward mapping rules specifies a behavior for a physical system simulation.

19. The method of claim 1, wherein the inverse mapping rule is output into a decision tree representation.

20. The method of claim 1, wherein the set of forward mapping rules is embedded in an object model specification.

21. The method of claim 1, wherein the set of forward mapping rules relates the input from the sensor to a sensor data interpretation.

22. The method of claim 1, wherein the set of forward mapping rules relates causes to effects in an engineered system.

23. The method of claim 1, wherein at least one of the inverse output parameters is a forward mapping rule input parameter.

24. A system, comprising:
a sensor;
a physical actuator;
a processor coupled to the sensor and the physical actuator, wherein the processor is configured to:
generate an inverse mapping rule from a set of forward mapping rules, comprising:
inputting the set of forward mapping rules;
determining a set of output parameters for the inverse mapping rule based at least in part on limiting the set of output parameters to be a subset of parameters for the set of forward mapping rules;
determining a set of input parameters for the inverse mapping rule based at least in part on limiting the set of input parameters to be: output parameters and input parameters of the set of forward mapping rules;
generating the inverse mapping rule for an input value combination, based at least in part on:
determining values of output parameters of the set of forward mapping rules based at least in part on the input value combination and the set of forward mapping rules;
determining a rule consequent of the inverse mapping rule at least in part by resolving values of a specified output parameter from the set of output parameters for the inverse mapping rule from the input value combination; and
determining a rule antecedent of the inverse mapping rule at least in part by resolving values of a specified input parameter from the set of input parameters for the inverse mapping rule from the determined values of output parameters of the set of forward mapping rules; and
outputting the inverse mapping rule;
receive input from the sensor; and
control the physical actuator based at least in part on the inverse mapping rule and the input from the sensor.

25. A computer program product embodied in a non-transitory computer readable medium and comprising computer instructions for:
generating an inverse mapping rule from a set of forward mapping rules, comprising:
inputting the set of forward mapping rules;
determining a set of output parameters for the inverse mapping rule based at least in part on limiting the set of output parameters to be a subset of parameters for the set of forward mapping rules;
determining a set of input parameters for the inverse mapping rule based at least in part on limiting the set of input parameters to be: output parameters and input parameters of the set of forward mapping rules;
generating the inverse mapping rule for an input value combination, based at least in part on:
determining values of output parameters of the set of forward mapping rules based at least in part on the input value combination and the set of forward mapping rules;
determining a rule consequent of the inverse mapping rule at least in part by resolving values of a specified output parameter from the set of output parameters for the inverse mapping rule from the input value combination; and
determining a rule antecedent of the inverse mapping rule at least in part by resolving values of a specified input parameter from the set of input parameters for the inverse mapping rule from the determined values of output parameters of the set of forward mapping rules; and
outputting the inverse mapping rule;
receiving input from a sensor; and
controlling a physical actuator based at least in part on the inverse mapping rule and the input from the sensor.
